(19) United States
(12) Patent Application Publication
(10) Pub. No.: US 2026/0045999 A1
(43) Pub. Date: Feb. 12, 2026

(54) PROCESSING METHOD, COMMUNICATION DEVICE AND STORAGE MEDIUM

(71) Applicant: Shanghai Transsion Co., Ltd., Shanghai (CN)

(72) Inventor: Sha WANG, Shanghai (CN)

(73) Assignee: Shanghai Transsion Co., Ltd., Shanghai (CN)

(21) Appl. No.: 19/366,433

(22) Filed: Oct. 22, 2025

Related U.S. Application Data
(63) Continuation of application No. PCT/CN2023/090705, filed on Apr. 25, 2023.

(51) Int. Cl. H04B 7/06; H04W 72/044; H04W 72/23

(52) U.S. Cl. CPC H04B 7/0626; H04W 72/044; H04W 72/23

(57) ABSTRACT

The technical solution of the present application generates or determines measurement resource configuration information of at least one channel state information reference signal based on downlink information, and provides a scheme for generating or determining measurement resource configuration information that can support dynamic adjustment of antenna ports, which can dynamically obtain channel state information of each antenna port to support network device to dynamically adjust antenna ports and/or reduce energy consumption of the network device.

### CROSS-REFERENCE TO RELATED APPLICATIONS

This application is a continuation application of International Application No. PCT/CN2023/090705, filed on Apr. 25, 2023. The disclosures of the above-mentioned application are incorporated herein by reference in their entirety.

### TECHNICAL FIELD

The present application relates to the technical field of communication, and in particular to a processing method, a communication device and a storage medium.

### BACKGROUND

In the current specification, a network device can determine channel state information (CSI) for a specified number of antenna ports based on a CSI report reported by a terminal device. The terminal device generates the CSI report based on the measurement resources of the Channel State Information-Reference Signal (CSI-RS) for the specified number of antenna ports. If the network device supports dynamic adjustment of the number of antenna ports, it needs to obtain CSI reports corresponding to different antenna port numbers and configure CSI-RS measurement resources for the terminal device with different antenna port numbers.

During the process of conceiving and implementing the present application, the inventors discovered at least the following problems: existing specifications stipulate that a single channel state information report can only contain channel state information for one number of antenna ports, making it difficult to dynamically configure measurement resources for different antenna port numbers, which results in an inability to support dynamic adjustment of antenna ports and/or high energy consumption of the network device.

Therefore, it is necessary to propose a scheme for generating or determining measurement resource configuration information that can support dynamic adjustment of antenna ports, so as to reduce energy consumption of network device.

The preceding description is intended to provide general background information and does not necessarily constitute prior art.

### SUMMARY

The main purpose of the present application is to provide a processing method, a communication device and a storage medium, aiming to provide a scheme for generating or determining measurement resource configuration information that can support dynamic adjustment of antenna ports, so as to reduce the energy consumption of network device.

To achieve the above objectives, the present application provides a processing method, which can be applied to a terminal device (such as a mobile phone), including the following steps:
S2: generating or determining measurement resource configuration information of at least one channel state information reference signal based on downlink information.

In an embodiment, the step S2 includes:
selecting or determining, based on the downlink information, the port numbers for a channel state information reference signal to be measured;
selecting or determining, based on the downlink information, higher-layer parameters for at least one group of channel state information reference signals with a certain port numbers that meet a preset rule; and
selecting or determining, based on the higher-layer parameters, a time domain resource location and/or a frequency domain resource location occupied by the channel state information reference signal in a slot.

In an embodiment, the meeting the preset rule includes at least one of the following:
at least one of a first frequency domain resource allocation, a first symbol of a first time domain, and a first symbol of a second time domain in the higher-layer parameters of the channel state information reference signals with different port numbers is the same;
the first frequency domain resource allocation in the higher-layer parameters of the channel state information reference signals with different port numbers is a subset of the first frequency domain resource allocation in the higher-layer parameters of the channel state information reference signal with the maximum port number in a resource pool where the port number resides.

In an embodiment, the selecting or determining, based on the downlink information, the port numbers for the channel state information reference signal to be measured includes at least one of the following:
determining the port numbers of at least one group of non-zero-power channel state information reference signals to be measured based on different bits in a first bit field of downlink control information; and
determining the maximum port number of non-zero-power channel state information reference signals to be measured based on a code point formed by all bits in a second bit field of the downlink control information; and
selecting or determining the port numbers of at least one group of non-zero-power channel state information reference signals to be measured based on the maximum port number.

In an embodiment, channel state information reference signals with different port numbers are located in the same code division multiplexing group and/or the same resource pool;
channel state information reference signals with different port numbers have the same or different non-zero power channel state information reference signal resource identifiers; and
channel state information reference signals with different port numbers have different non-zero power channel state information reference signal resource set identifiers.

In an embodiment, the method further includes:
obtaining channel state information of an antenna port where the channel state information reference signal is located based on the measurement resource configuration information.

In an embodiment, the downlink information is downlink control information and/or radio resource control information;
the channel state information reference signal is a non-zero-power channel state information reference signal and/or a zero-power channel state information reference signal; and
the channel state information is at least one of a channel quality indicator, a precoding matrix indicator, a channel state information reference signal resource indicator, a layer indicator, a rank indicator, a layer 1 reference signal reception quality, and a layer 1 signal-to-noise ratio.

In an embodiment, the method further includes at least one of the following:
the downlink information is specific to each terminal device;
the downlink information is shared by the terminal devices in a preset group;
the downlink information is shared by all terminal devices within a preset cell.

In an embodiment, the method further includes at least one of the following:
terminal devices belonging to the same preset group must have the same quality of service requirements;
the reference signal received power of terminal devices belonging to the same preset group is greater than a first preset threshold and does not exceed a second preset threshold.

The present application further provides a processing method, which can be applied to a network device (such as a base station), including the following step:

S1: transmitting downlink information, enabling a terminal device to generate or determine measurement resource configuration information of at least one channel state information reference signal based on the downlink information.

In an embodiment, the downlink information is specific to each terminal device;
the downlink information is shared by the terminal devices in a preset group; and
the downlink information is shared by all terminal devices within a preset cell.

In an embodiment, terminal devices belonging to the same preset group have the same quality of service requirements; and
reference signal received power of terminal devices belonging to the same preset group is greater than a first preset threshold and does not exceed a second preset threshold.

In an embodiment, the method further includes:
configuring number of antenna ports required for physical downlink shared channel transmission based on channel state information.

The technical solutions of the present application, by generating or determining measurement resource configuration information of at least one channel state information reference signal based on downlink information, provides a scheme for generating or determining measurement resource configuration information that can support dynamic adjustment of antenna ports, which is used to dynamically obtain channel state information of each antenna port, so as to support dynamically adjust antenna ports and/or reduce the energy consumption of network device.

### BRIEF DESCRIPTION OF THE DRAWINGS

The accompanying drawings, which are incorporated in and constitute a part of this specification, illustrate embodiments consistent with the present application and together with the description, serve to explain the principles of the present application. In order to explain the technical solutions of the embodiments of the present application more clearly, the drawings needed to be used in the description of the embodiments will be briefly introduced below. Obviously, for those of ordinary skill in the art, other drawings can be obtained based on these drawings without exerting creative efforts.

FIG. 1 is a schematic diagram of hardware structure of a mobile terminal that implements various embodiments of the present application.

FIG. 2 is a communication network system architecture diagram according to an embodiment of the present application.

FIG. 3 is a schematic diagram of the hardware structure of a controller 140 provided in the present application.

FIG. 4 is a schematic diagram of the hardware structure of a network node 150 provided in the present application.

FIG. 5 is a schematic flowchart of a processing method according to a first embodiment.

FIG. 6 is a schematic flowchart of a processing method according to a second embodiment.

FIG. 7 is a schematic diagram of a first example of a processing method according to the second embodiment.

FIG. 8 is a schematic diagram of a second example of a processing method according to the second embodiment.

FIG. 9 is a schematic diagram of a third example of a processing method according to the second embodiment.

FIG. 10 is a schematic diagram of a first example of a processing method according to a third embodiment.

FIG. 11 is a schematic diagram of a second example of a processing method according to the third embodiment.

FIG. 12 is a schematic diagram of a third example of a processing method according to the third embodiment.

FIG. 13 is a schematic diagram of a first example of a processing method according to a fifth embodiment.

FIG. 14 is a schematic diagram of a second example of a processing method according to the fifth embodiment.

FIG. 15 is a schematic diagram of a third example of a processing method according to the fifth embodiment.

FIG. 16 is a schematic flowchart of a processing method according to a ninth embodiment.

FIG. 17 is a schematic diagram of an interaction sequence according to a tenth embodiment.

FIG. 18 is a first schematic structural diagram of a processing device provided in an embodiment of the present application.

FIG. 19 is a second schematic structural diagram of a processing device provided in an embodiment of the present application.

FIG. 20 is a schematic structural diagram of a communication device provided in an embodiment of the present application.

The realization of the purpose, functional features and advantages of the present application will be further described in conjunction with the embodiments and with reference to the accompanying drawings. The above-mentioned drawings have shown clear embodiments of the present application, which will be described in more detail later. These drawings and textual descriptions are not intended to limit the scope of the concept of the present application in any way, but to illustrate the concept of the present application to those skilled in the art by referring to specific embodiments.

### DETAILED DESCRIPTION OF THE EMBODIMENTS

Exemplary embodiments will be described in detail herein, examples of which are illustrated in the accompanying drawings. When the following description refers to the drawings, unless otherwise indicated, the same numbers in different drawings refer to the same or similar elements. The implementations described in the following exemplary embodiments do not represent all implementations consistent with the present application. Rather, they are merely examples of apparatus and methods consistent with aspects of the present application as detailed in the appended claims.

It should be noted that in this document, the terms “comprise”, “include” or any other variants thereof are intended to cover a non-exclusive inclusion. Thus, a process, method, article, or system that includes a series of elements not only includes those elements, but also includes other elements that are not explicitly listed, or also includes elements inherent to the process, method, article, or system. If there are no more restrictions, the element defined by the sentence “including a . . . ” does not exclude the existence of other identical elements in the process, method, article or system that includes the element. In addition, components, features, and elements with the same name in different embodiments of the present application may have the same or different meanings. Its specific meaning needs to be determined according to its explanation in the specific embodiment or further combined with the context in the specific embodiment.

It should be understood that although the terms first, second, third, etc. may be used herein to describe various information, the information should not be limited to these terms. These terms are only used to distinguish information of the same type from one another. For example, without departing from the scope of this document, first information may also be called second information, and similarly, second information may also be called first information. Depending on the context, the word “if” as used herein may be interpreted as “at” or “when” or “in response to a determination”. Furthermore, as used herein, the singular forms “a”, “an” and “the” are intended to include the plural forms as well, unless the context indicates otherwise. It should be further understood that the terms “comprising”, “including” indicate the existence of features, steps, operations, elements, components, items, species, and/or groups, but does not exclude the existence, occurrence or addition of one or more other features, steps, operations, elements, components, items, species, and/or groups. The terms “or”, “and/or”, “comprising at least one of” and the like used in the present application may be interpreted as inclusive, or mean any one or any combination. For example, “comprising at least one of: A, B, C” means “any of: A; B; C; A and B; A and C; B and C; A and B and C”. As another example, “A, B, or C” or “A, B, and/or C” means “any of the following: A; B; C; A and B; A and C; B and C; A and B and C”. Exceptions to this definition will only arise when combinations of elements, functions, steps or operations are inherently mutually exclusive in some way.

It should be understood that although the various steps in the flowchart in the embodiment of the present application are displayed sequentially as indicated by the arrows, these steps are not necessarily executed sequentially in the order indicated by the arrows. Unless otherwise specified herein, there is no strict order restriction on the execution of these steps, and they can be executed in other orders. Moreover, at least some of the steps in the figure may include multiple sub-steps or multiple stages, these sub-steps or stages are not necessarily executed at the same time, but can be executed at different times. The execution sequence thereof is not necessarily performed sequentially, but may be performed alternately or alternately with at least one part of other steps or sub-steps or stages of other steps.

Depending on the context, the words “if” as used herein may be interpreted as “at” or “when” or “in response to determining” or “in response to detecting”. Similarly, depending on the context, the phrases “if determined” or “if detected (the stated condition or event)” could be interpreted as “when determined” or “in response to the determination” or “when detected (the stated condition or event)” or “in response to detection (the stated condition or event)”.

It should be noted that in this article, step codes such as S1 and S2 are used for the purpose of expressing the corresponding content more clearly and concisely, and do not constitute a substantial restriction on the order. When implementing the step, those skilled in the art may execute S2 first and then S1, etc., but these should all be within the scope of protection of the present application.

It should be understood that the specific embodiments described here are only used to explain the present application, and are not intended to limit the present application.

In the following description, the use of suffixes such as “module”, “part” or “unit” for denoting elements is only for facilitating the description of the present application and has no specific meaning by itself. Therefore, “module”, “part” or “unit” may be used in combination.

The communication device mentioned in the present application can be a terminal device (such as a mobile terminal, specifically a mobile phone) or a network device (such as a base station). The specific reference needs to be clarified in the context. The terminal device can be implemented in various forms. For example, the terminal device described in the present application can include a mobile phone, a tablet computer, a notepad computer, a hand-held computer, a personal digital assistants (PDA), a portable media player (PMP), a navigation device, a wearable device, a smart bracelet, a pedometer and other terminal devices, as well as a fixed terminal device such as a digital TV and a desktop computer.

The present application takes a mobile terminal as an example to illustrate. Those skilled in the art will understand that, in addition to elements specifically used for mobile purposes, the configuration according to the embodiments of the present application can also be applied to the fixed terminal device.

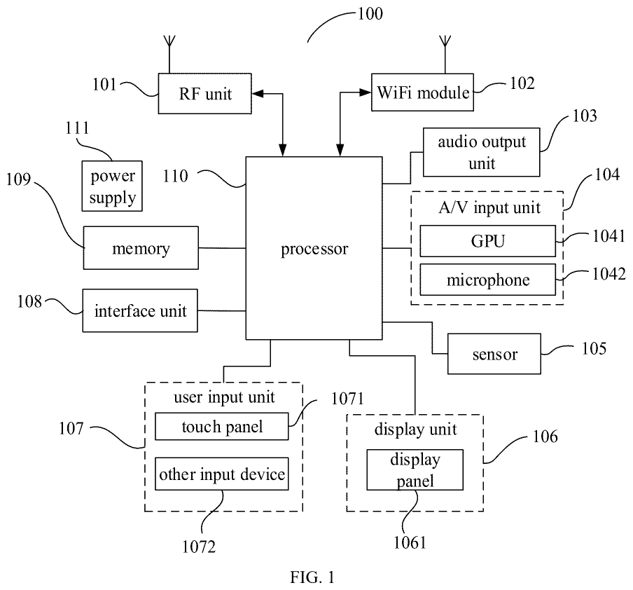

As shown in FIG. 1, FIG. 1 is a schematic structural diagram of a hardware of a mobile terminal that implements various embodiments of the present application. The mobile terminal 100 can include a Radio Frequency (RF) unit 101, a WiFi module 102, an audio output unit 103, an audio/video (A/V) input unit 104, a sensor 105, a display unit 106, a user input unit 107, an interface unit 108, a memory 109, a processor 110, a power supply 111 and other components. Those skilled in the art can understand that the structure of the mobile terminal shown in FIG. 1 does not constitute a limitation on the mobile terminal. The mobile terminal can include more or fewer components, or a combination of some components, or differently arranged components than shown in the figure.

Hereinafter, each component of the mobile terminal will be specifically introduced with reference to FIG. 1.

The radio frequency unit 101 can be used for transmitting and receiving signals during the process of transceiving information or talking. Specifically, after receiving the downlink information of the base station, the downlink information is processed by the processor 110; in addition, the uplink data is sent to the base station. Generally, the radio frequency unit 101 includes, but is not limited to, an antenna, at least one amplifier, a transceiver, a coupler, a low noise amplifier, a duplexer, and the like. In addition, the radio frequency unit 101 can also communicate with the network and other devices through wireless communication. The above-mentioned wireless communication can use any communication standard or protocol, including but not limited to Global System of Mobile communication (GSM), General Packet Radio Service (GPRS), Code Division Multiple Access 2000 (CDMA2000), Wideband Code Division Multiple Access (WCDMA), Time Division-Synchronous Code Division Multiple Access (TD-SCDMA), Frequency Division Duplexing-Long Term Evolution (FDD-LTE), Time Division Duplexing-Long Term Evolution (TDD-LTE), and 5G, or the like.

Wi-Fi is a short-range wireless transmission technology. The mobile terminal can help users transmit and receive email, browse webpage, and access streaming media through the Wi-Fi module 102, and Wi-Fi provides users with wireless broadband Internet access. Although FIG. 1 shows the Wi-Fi module 102, it is understandable that it is not a necessary component of the mobile terminal and can be omitted as needed without changing the essence of the present application.

When the mobile terminal 100 is in a call signal receiving mode, a call mode, a denoting mode, a voice recognition mode, a broadcast receiving mode, or the like, the audio output unit 103 can convert the audio data received by the radio frequency unit 101 or the Wi-Fi module 102 or stored in the memory 109 into an audio signal and output the audio signal as sound. Moreover, the audio output unit 103 can also provide audio output related to a specific function performed by the mobile terminal 100 (for example, call signal reception sound, message reception sound, or the like). The audio output unit 103 can include a speaker, a buzzer, or the like.

The A/V input unit 104 is configured to receive audio or video signals. The A/V input unit 104 can include a graphics processing unit (GPU) 1041 and a microphone 1042. The graphics processing unit 1041 processes image data of still pictures or videos obtained by an image capture device (such as a camera) in a video capture mode or an image capture mode. The processed image frame can be displayed on the display unit 106. The image frame processed by the graphics processing unit 1041 can be stored in the memory 109 (or other storage medium) or sent via the radio frequency unit 101 or the Wi-Fi module 102. The microphone 1042 can receive sound (audio data) in operation modes such as a call mode, a denoting mode, a voice recognition mode, and the like, and can process such sound into audio data. The processed audio (voice) data can be converted into a format that can be sent to a mobile communication base station via the radio frequency unit 101 in the case of a call mode for output. The microphone 1042 can implement various types of noise cancellation (or suppression) algorithms to eliminate (or suppress) noise or interference generated during the process of transceiving audio signals.

The mobile terminal 100 also includes at least one sensor 105, such as a light sensor, a motion sensor, and other sensors. Specifically, the light sensor includes an ambient light sensor and a proximity sensor. The ambient light sensor can adjust the brightness of the display panel 1061 according to the brightness of the ambient light. The proximity sensor can turn off the display panel 1061 and/or the backlight when the mobile terminal 100 is moved to the ear. A gravity acceleration sensor, as a kind of motion sensor, can detect the magnitude of acceleration in various directions (usually three axes). The gravity acceleration sensor can detect the magnitude and direction of gravity when it is stationary, and can identify the gesture of the mobile terminal (such as horizontal and vertical screen switch, related games, magnetometer attitude calibration), vibration recognition related functions (such as pedometer, tap), or the like. The mobile terminal can also be equipped with other sensors such as a fingerprint sensor, a pressure sensor, an iris sensor, a molecular sensor, a gyroscope, a barometer, a hygrometer, a thermometer, an infrared sensor and other sensors, which will not be repeated herein.

The display unit 106 is configured to display information input by the user or information provided to the user. The display unit 106 can include a display panel 1061, and the display panel 1061 can be configured in the form of a liquid crystal display (LCD), an organic light emitting diode (OLED), or the like.

The user input unit 107 can be configured to receive inputted numeric or character information, and generate key signal input related to user settings and function control of the mobile terminal. Specifically, the user input unit 107 can include a touch panel 1071 and other input devices 1072. The touch panel 1071, also called a touch screen, can collect user touch operations on or near it (for example, the user uses fingers, stylus and other suitable objects or accessories to operate on the touch panel 1071 or near the touch panel 1071), and drive the corresponding connection device according to a preset program. The touch panel 1071 can include two parts: a touch detection device and a touch controller. The touch detection device detects the user's touch position, detects the signal brought by the touch operation, and transmits the signal to the touch controller. The touch controller receives the touch information from the touch detection device, converts the touch information into contact coordinates, and transmits it to the processor 110, and can receive and execute the instructions sent by the processor 110. In addition, the touch panel 1071 can be implemented in multiple types such as resistive, capacitive, infrared, and surface acoustic wave. In addition to the touch panel 1071, the user input unit 107 can also include other input devices 1072. Specifically, the other input devices 1072 can include, but are not limited to, one or more of physical keyboard, function keys (such as volume control buttons, switch buttons, etc.), trackball, mouse, joystick, etc., which are not specifically limited here.

Further, the touch panel 1071 can cover the display panel 1061. After the touch panel 1071 detects a touch operation on or near it, the touch operation is transmitted to the processor 110 to determine the type of the touch event, and then the processor 110 provides a corresponding visual output on the display panel 1061 according to the type of the touch event. Although in FIG. 1, the touch panel 1071 and the display panel 1061 are used as two independent components to realize the input and output functions of the mobile terminal, in some embodiments, the touch panel 1071 and the display panel 1061 can be integrated to implement the input and output functions of the mobile terminal, which is not specifically limited here.

The interface unit 108 serves as an interface through which at least one external device can be connected to the mobile terminal 100. For example, the external device can include a wired or wireless earphone port, an external power source (or battery charger) port, a wired or wireless data port, a memory card port, a port for connecting devices with identification modules, an audio input/output (I/O) port, a video I/O port, an earphone port, or the like. The interface unit 108 can be configured to receive input (such as data information, electricity, or the like) from an external device and transmit the received input to one or more elements in the mobile terminal 100 or can be configured to transfer data between the mobile terminal 100 and the external device.

The memory 109 can be configured to store software programs and various data. The memory 109 can mainly include a program storage area and a data storage area. The program storage area can store the operating system, at least one application required by the function (such as sound play function, image play function, etc.), or the like. The data storage area can store data (such as audio data, phone book, etc.) created based on the use of the mobile phone. In addition, the memory 109 can include a high-speed random access memory, and can also include a non-volatile memory, such as at least one magnetic disk storage device, a flash memory device, or other volatile solid-state storage devices.

The processor 110 is a control center of the mobile terminal, and uses various interfaces and lines to connect the various parts of the entire mobile terminal. By running or performing the software programs and/or modules stored in the memory 109, and calling the data stored in the memory 109, various functions and processing data of the mobile terminal are executed, thereby overall monitoring of the mobile terminal is performed. The processor 110 can include one or more processing units; and the processor 110 may integrate an application processor and a modem processor. The application processor mainly processes an operating system, a user interface, an application, or the like, and the modem processor mainly processes wireless communication. It can be understood that the foregoing modem processor may not be integrated into the processor 110.

The mobile terminal 100 can also include a power source 111 (such as a battery) for supplying power to various components. The power supply 111 can be logically connected to the processor 110 through a power management system, so that functions such as charging, discharging, and power consumption management can be managed through the power management system.

Although not shown in FIG. 1, the mobile terminal 100 can also include a BLUETOOTH module, or the like, which will not be repeated herein.

In order to facilitate the understanding of the embodiments of the present application, the following describes the communication network system on which the mobile terminal of the present application is based.

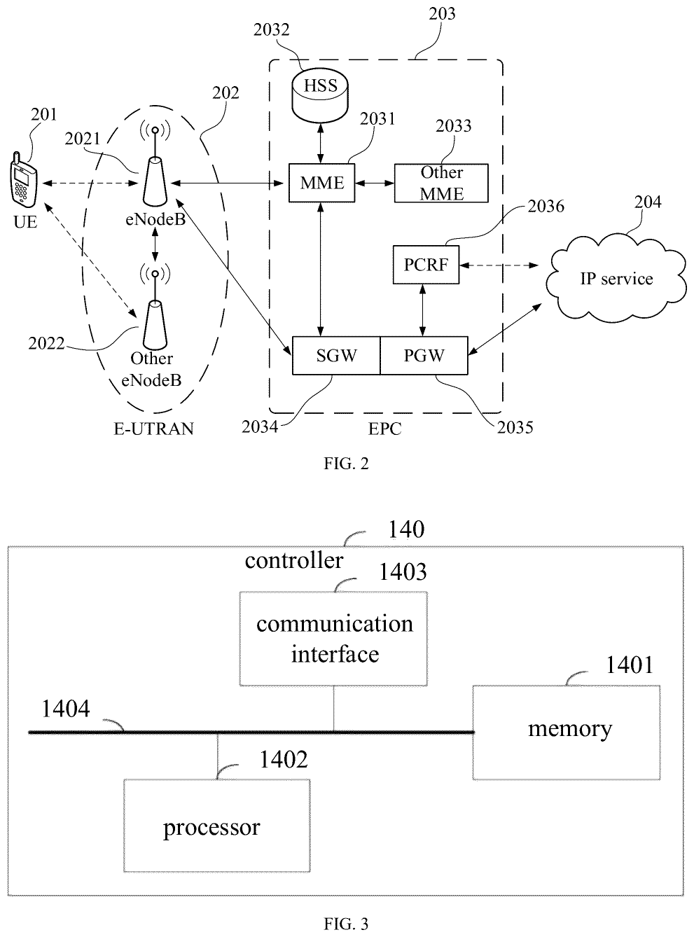

As shown in FIG. 2, FIG. 2 is a communication network system architecture diagram according to an embodiment of the present application. The communication network system is an LTE system of general mobile communication network technology. The LTE system includes a User Equipment (UE) 201, an Evolved UMTS Terrestrial Radio Access Network (E-UTRAN) 202, an Evolved Packet Core (EPC) 203, and an operator's IP service 204 that are sequentially connected in communication.

Optionally, the UE 201 can be the aforementioned terminal 100, which will not be repeated here.

E-UTRAN 202 includes eNodeB 2021 and other eNodeBs 2022. The eNodeB 2021 can be connected to other eNodeBs 2022 through a backhaul (for example, an X2 interface), the eNodeB 2021 is connected to the EPC 203, and the eNodeB 2021 can provide access from the UE 201 to the EPC 203.

The EPC 203 can include Mobility Management Entity (MME) 2031, Home Subscriber Server (HSS) 2032, other MMEs 2033, Serving Gate Way (SGW) 2034, PDN Gate Way (PGW) 2035, Policy and Charging Rules Function (PCRF) 2036, and so on. MME 2031 is a control node that processes signaling between UE 201 and EPC 203, and provides bearer and connection management. HSS 2032 is configured to provide some registers to manage functions such as the home location register (not shown), and save some user-specific information about service feature, data rates, and so on. All user data can be sent through SGW 2034, PGW 2035 can provide UE 201 IP address allocation and other functions. PCRF 2036 is a policy and charging control policy decision point for service data flows and IP bearer resources, which selects and provides available policy and charging control decisions for policy and charging execution functional units (not shown).

The IP service 204 can include Internet, intranet, IP Multimedia Subsystem (IMS), or other IP services.

Although the LTE system is described above as an example, those skilled in the art should know that, the present application is not only applicable to the LTE system, but also applicable to other wireless communication systems, such as GSM, CDMA2000, WCDMA, TD-SCDMA, 5G and new network systems in the future (such as 6G), or the like, which is not limited herein.

Based on the above-mentioned mobile terminal hardware structure and communication network system, various embodiments of the present application are proposed.

FIG. 3 is a schematic diagram of the hardware structure of a controller 140 provided in the present application. The controller 140 includes a memory 1401 and a processor 1402, the memory 1401 is configured to store program instructions, and the processor 1402 is configured to call the program instructions in the memory 1401 to execute the steps performed by the controller in the first embodiment of the above-mentioned method. The implementation principle and beneficial effects are similar and will not be repeated here.

Optionally, the above-mentioned controller also includes a communication interface 1403, which can be connected to the processor 1402 through a bus 1404. The processor 1402 can control the communication interface 1403 to realize the receiving and sending functions of the controller 140.

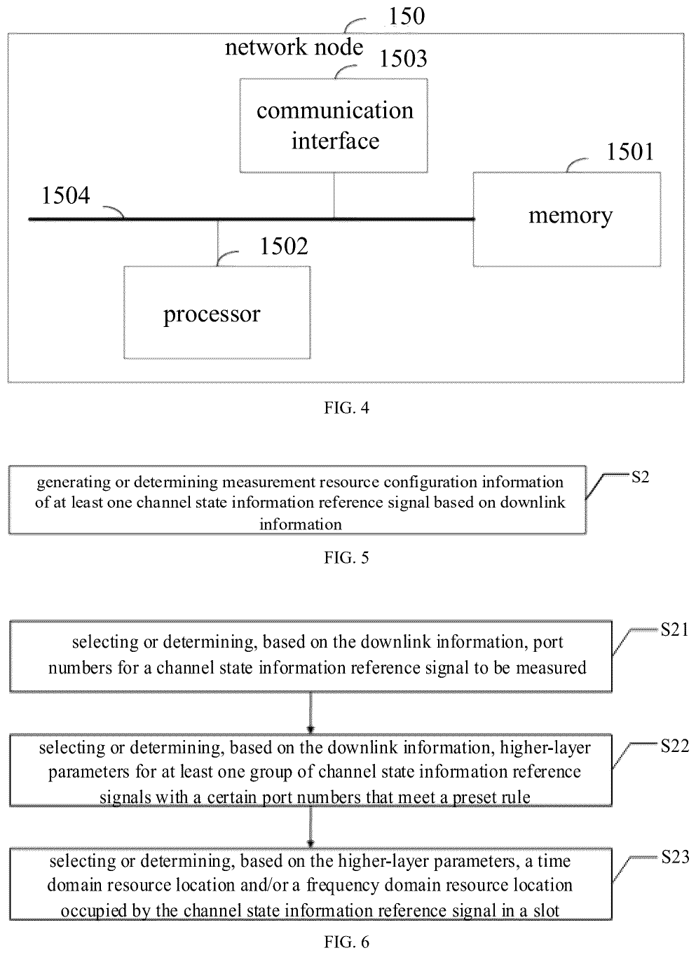

FIG. 4 is a schematic diagram of the hardware structure of a network node 150 provided in the present application. The network node 150 includes a memory 1501 and a processor 1502. The memory 1501 is configured to store program instructions, and the processor 1502 is configured to call the program instructions in the memory 1501 to execute the steps performed by the first node in the first embodiment of the above method. The implementation principle and beneficial effects are similar and will not be repeated here.

Optionally, the above controller also includes a communication interface 1503, which can be connected to the processor 1502 through a bus 1504. The processor 1502 can control the communication interface 1503 to implement the receiving and sending functions of the network node 150.

The above-mentioned integrated module implemented in the form of a software function module can be stored in a computer-readable storage medium. The above-mentioned software function module is stored in a storage medium, including several instructions for enabling a computer device (which can be a personal computer, a server, or a network device, etc.) or a processor to perform some steps of the methods of various embodiments of the present application.

The above embodiments can be implemented in whole or in part by software, hardware, firmware or any combination thereof. When implemented by software, it can be implemented in whole or in part in the form of a computer program product. The computer program product includes one or more computer instructions. When the computer program instructions are loaded and executed on the computer, the process or function according to the embodiment of the present application is generated in whole or in part. The computer can be a general-purpose computer, a special-purpose computer, a computer network, or other programmable device. The computer instructions can be stored in a computer-readable storage medium, or transmitted from one computer-readable storage medium to another computer-readable storage medium. For example, the computer instructions can be transmitted from one website, computer, server or data center to another website, computer, server or data center by wired (such as coaxial cable, optical fiber, digital subscriber line (DSL)) or wireless (such as infrared, wireless, microwave, etc.) means. The computer-readable storage medium can be any available medium that can be accessed by the computer or a data storage device such as a server or data center that includes one or more available media integrated. The available medium can be a magnetic medium (such as a floppy disk, a storage disk, a tape), an optical medium (such as a DVD), or a semiconductor medium (such as a Solid State Disk (SSD)), etc.

Based on the above-mentioned mobile terminal hardware structure and communication network system, various embodiments of the present application are proposed.

### First Embodiment

As shown in FIG. 5, FIG. 5 is a flowchart illustrating a processing method according to a first embodiment, the processing method of this embodiment of the present application can be applied to a terminal device (e.g., a mobile phone) and includes the following steps:
S2: generating or determining measurement resource configuration information of at least one channel state information reference signal based on downlink information.

In an embodiment of the present application, the network device needs to dynamically adjust the number of antenna ports for Physical Downlink Shared CHannel (PDSCH) transmission based on the channel state information corresponding to different antenna port numbers. In the existing specification, the channel state information is obtained by the terminal device measuring the measurement resources of CSI-RS, and then reported to the network device. Therefore, in order to achieve the purpose of dynamically adjusting the number of PDSCH transmission antenna ports by the network device, it is necessary to consider how to configure the measurement resources of CSI-RS with different port numbers for the terminal device. In the present application, the terminal device can generate or determine the measurement resource configuration information of at least one channel state information reference signal based on the downlink information.

Optionally, the downlink information is Downlink Control Information (DCI) and/or Radio Resource Control (RRC) information.

Optionally, the channel state information reference signal is a non-zero-power channel state information reference signal or a zero-power channel state information reference signal.

Optionally, the channel state information is at least one of a channel quality indicator, a precoding matrix indicator, a channel state information reference signal resource indicator, a layer indicator, a rank indicator, a layer 1 reference signal received quality, and a layer 1 signal-to-noise ratio.

Optionally, the downlink information is specific to each terminal device.

Optionally, the downlink information is shared by the terminal devices in a preset group.

Optionally, the downlink information is shared by all terminal devices within a preset cell.

Optionally, terminal devices belonging to the same preset group must have the same quality of service requirements, such as transmission code block size and transmission rate.

Optionally, the reference signal received power of terminal devices belonging to the same preset group is greater than a first preset threshold and not exceed a second preset threshold.

Optionally, if the downlink information is specific to each terminal device and the downlink information is DCI, the DCI may also include trigger indication information for the CSI report.

Optionally, after receiving the downlink information, the terminal device can select or determine the port numbers for the channel state information reference signal to be measured based on the downlink information, and can further determine the measurement resource configuration information of at least one channel state information reference signal in combination with the high-layer parameters corresponding to the channel state information reference signal with at least one group of port numbers that meet preset rules.

Optionally, the measurement resource configuration information for the channel state information reference signal includes the time domain resource and/or frequency domain resource location occupied by the channel state information reference signal in the slot where the channel state information reference signal is located.

Optionally, after the terminal device generates or determines the measurement resource configuration information of at least one channel state information reference signal based on downlink information, it can obtain channel state information corresponding to the channel state information reference signal for different antenna port numbers based on the measurement resource configuration information, allowing the network device to dynamically adjust the number of antenna ports.

Optionally, in this embodiment of the present application, channel state information reference signals with different port numbers can have the same or different non-zero-power channel state information reference signal resource identifiers.

Optionally, channel state information reference signals with different port numbers may also have different non-zero-power channel state information reference signal resource set identifiers.

Optionally, when channel state information reference signals with different port numbers have the same non-zero-power channel state information reference signal resource identifier, at least one of the first frequency domain resource allocation (frequencyDomainAllocation), the first symbol in the first time domain (firstOFDMSymbolInTimeDomain), and the first symbol in the second time domain (firstOFDMSymbolInTimeDomain2) in the higher layer parameters of the channel state information reference signals with different port numbers may be the same.

Optionally, when CSI reference signals with different port numbers have the same non-zero-power CSI reference signal resource identifier, the density, code division multiplexing type (cdm-Type), and/or frequency domain range (freqBand) in the higher-layer parameters of the CSI reference signals with different port numbers are the same.

Optionally, when CSI reference signals with different port numbers have the same non-zero-power CSI reference signal resource identifier, the port numbers of CSI reference signal to be measured can be determined by downlink control information.

Optionally, the downlink control information includes an X-bit port number indication bit, and optionally, each bit among the X bits corresponds to the port numbers of CSI reference signal to be measured.

Optionally, the downlink control information includes a Y-bit maximum port number indication bit. Optionally, the Y-bit code point is used to indicate the maximum port number in a measurement set consisting of channels state information reference signal ports to be measured. After obtaining the maximum port number, the port numbers of all channels state information reference signal to be measured needs to be determined based on the resource pool where the number of channels state information reference signal ports to be measured is located.

Optionally, when CSI reference signals with different port numbers have the same non-zero-power CSI reference signal resource identifier, the port numbers of the CSI reference signal to be measured is located in the same resource pool. For example, the port numbers of the CSI reference signal to be measured corresponding to the positions set to 1 in the X bit is located in the same resource pool. Similarly, the port numbers of the CSI reference signal to be measured, as determined by the Y bit, is also located in the same resource pool.

Optionally, when CSI reference signals with different port numbers have different non-zero-power CSI reference signal resource identifiers, the first frequency domain resource allocation (frequencyDomainAllocation) in the higher-layer parameters of the CSI reference signals with different port numbers is a subset of the first frequency domain resource allocation (frequencyDomainAllocation) in the higher-layer parameters of the CSI reference signal with the maximum port number in the resource pool containing the port numbers of the CSI reference signal to be measured.

Optionally, when CSI reference signals with different port numbers have different non-zero-power CSI reference signal resource identifiers, at least one of the code division multiplexing type (cdm-Type), density, frequency domain range (freqBand), first symbol of the first time domain (firstOFDMSymbolInTimeDomain), and first symbol of the second time domain (firstOFDMSymbolInTimeDomain2) in the higher-layer parameters of the CSI reference signals with different port numbers is the same.

Optionally, when CSI reference signals with different port numbers have different non-zero-power CSI reference signal resource set identifiers, the first frequency domain resource allocation (FrequencyDomainAllocation) in the higher-layer parameters of the CSI reference signals with different port numbers is a subset of the first frequency domain resource allocation (FrequencyDomainAllocation) in the higher-layer parameters of the CSI reference signal with the maximum port number in the resource pool containing the port numbers of the CSI reference signal to be measured.

Optionally, when CSI reference signals with different port numbers have different non-zero-power CSI reference signal resources or resource set identifiers, the port numbers of CSI reference signal to be measured can be determined via radio resource control information and/or downlink control information.

Optionally, the port numbers of CSI reference signal to be measured can be statically configured via radio resource control information. For example, if two antenna port numbers need to be measured, the radio resource control information only sequentially configures the measurement resources for the CSI reference signals corresponding to the two antenna port numbers. Optionally, if the number of the two antenna ports is 16 ports and 32 ports respectively, it is only necessary to sequentially configure the measurement resources of the channel state information reference signals of 16 ports and 32 ports through the radio resource control information, and then the terminal obtains the port numbers of channel state information reference signal to be measured according to the radio resource control information.

Optionally, the measurement resources of the channel state information reference signals of all antenna ports in the resource pool where the port numbers for the channel state information reference signals to be measured is located can be configured in the radio resource control information; and then the port numbers for the channel state information reference signals to be measured is determined through the downlink control information.

In technical solutions of this embodiment, by generating or determining measurement resource configuration information of at least one channel state information reference signal based on the downlink information, a scheme for generating or determining measurement resource configuration information that can support different antenna port numbers is provided, which is used to obtain channel state information corresponding to different antenna port numbers, and to support network device to dynamically adjust antenna ports and/or reduce energy consumption of the network device.

### Second Embodiment

Based on the first embodiment of the present application, this embodiment discloses a specific method of step S2. As shown in FIG. 6, FIG. 6 is a flowchart of a processing method according to the second embodiment, showing that step S2 includes the following steps:
S21: selecting or determining, based on the downlink information, the port numbers for a channel state information reference signal to be measured;
S22: selecting or determining, based on the downlink information, higher-layer parameters for at least one group of channel state information reference signals with a certain port numbers that meet a preset rule; and
S23: selecting or determining, based on the higher-layer parameters, a time domain resource location and/or a frequency domain resource location occupied by the channel state information reference signal in a slot.

Optionally, selecting or determining, based on the downlink information, the port numbers for a channel state information reference signal to be measured includes at least one of the following:
determining the port numbers of at least one group of non-zero-power CSI reference signals to be measured based on different bits in a first bit field in the downlink control information;
determining the maximum port number of non-zero-power CSI reference signals to be measured based on a code point formed by all bits in a second bit field of the downlink control information, and
selecting or determining the port numbers of at least one group of non-zero-power CSI reference signals to be measured based on the maximum port number.

Optionally, the meeting the preset rule includes at least one of the following:
at least one of the first frequency domain resource allocation (frequencyDomainAllocation), the first symbol of the first time domain (firstOFDMSymbolInTimeDomain), and the first symbol of the second time domain (firstOFDMSymbolInTimeDomain2) in the higher-layer parameters of the channel state information reference signals with different port numbers is the same;
the first frequency domain resource allocation in the higher-layer parameters of the channel state information reference signals with different port numbers is a subset of the first frequency domain resource allocation in the higher-layer parameters of the channel state information reference signal with the maximum port number in the resource pool where the port number resides.

Optionally, channel state information reference signals with different port numbers are located in the same code division multiplexing group and/or the same resource pool.

Optionally, channel state information reference signals with different port numbers may have the same non-zero-power channel state information reference signal resource identifier.

Optionally, channel state information reference signals with different port numbers may also have different non-zero-power channel state information reference signal resource identifiers.

Optionally, channel state information reference signals with different port numbers may have different non-zero-power channel state information reference signal resource set identifiers.

Optionally, when channel state information reference signals with different port numbers have the same non-zero power channel state information reference signal resource identifier, the RRC configuration of their CSI-RS resource mapping is as follows:

```
  CSI-RS-ResourceMapping ::= SEQUENCE {
      frequencyDomainAllocation CHOICE {
```

| | |
|---|---|
| row1 | BIT STRING (SIZE (4)), |
| row2 | BIT STRING (SIZE (12)), |
| row4 | BIT STRING (SIZE (3)), |
| other | BIT STRING (SIZE (6)) |

},

| | |
|---|---|
| nrofPorts | ENUMERATED {p1,p2,p4,p8,p12,p16,p24,p32}, |
| firstOFDMSymbolInTimeDomain | INTEGER (0..13), |
| firstOFDMSymbolInTimeDomain2 | INTEGER (2..12) OPTIONAL, -- Need R |
| cdm-Type | ENUMERATED {noCDM, fd-CDM2, cdm4-FD2-TD2, cdm8- |

FD2-TD4},
density CHOICE {

| | |
|---|---|
| dot5 | ENUMERATED {evenPRBs, oddPRBs}, |
| one | NULL, |
| three | NULL, |
| spare | NULL |

},

| | |
|---|---|
| freqBand | CSI-FrequencyOccupation, |

```
      ...
  }
  CSI-FrequencyOccupation ::= SEQUENCE {
```

| | |
|---|---|
| startingRB | INTEGER (0..maxNrofPhysicalResourceBlocks-1), |
| nrofRBs | INTEGER (24..maxNrofPhysicalResourceBlocksPlus1), |

```
      ...
  }
```

Optionally, when CSI reference signals with different port numbers have the same non-zero-power CSI reference signal resource identifier, the resource pool for the port numbers to be measured is determined based on at least one of the higher-layer parameters: code division multiplexing type (cdm-Type) and port numbers (nrofPorts).

Optionally, the code division multiplexing type is fd-CDM2. If the resource pool partitioning method of Table 1 is used, there are two resource pools for the port numbers to be measured. If nrofPorts=32, the resource pools for the port numbers to be measured are {p32, p24, p16, p8, p4, p2}. If nrofPorts=24, the resource pools for the port numbers to be measured are {24, 8, 4, 2}.

Optionally, Table 1 is defined as follows:

TABLE 1
Example of port number resource pool

| Code division multiplexing type | Port List |
|---|---|
| noCDM | {1} |
| fd-CDM2 (remove row4) | {p32, p24, p16, p8, p4, p2} or |
| | {p24, p8, p4, p2} |
| cdm4-FD2-TD2 | {p32, p24, p16, p12, p8} or |
| | {p24, p12, p8} |
| cdm8-FD2-TD4 | {p32, p24} |

Optionally, when CSI reference signals with different port numbers have the same non-zero-power CSI reference signal resource identifier, the port numbers of CSI reference signal to be measured can be determined based on the downlink control information.

Optionally, the downlink control information includes an X-bit port number indication bit, where each bit among the X bits respectively represents the number of antenna ports to be measured. Optionally, the port numbers for the channel state information reference signal to be measured indicated by the X bit is located in the same resource pool. For example, Table 1 shows an example of a resource pool grouped according to code division multiplexing type. Taking the CDM type of fd-CDM2 as an example, if nrofPorts=32, then according to Table 1, the resource pool is {p32, p24, p16, p8, p4, p2}. Optionally, X=8, that is, the port indication bit contains 8 bits, and from the most significant bit to least significant bit, it corresponds to the number of antenna ports p32, p24, p16, p12, p8, p4, p2, and p1, respectively. Then, the bits 00101110 represent that the set of antenna port numbers to be measured is {p16, p8, p4, p2}.

Optionally, when channel state information reference signals with different port numbers have the same non-zero power channel state information reference signal resource identifier, another method for determining the port number of the channel state information reference signal to be measured through downlink control information is: the downlink control information contains a Y-bit maximum port number indication bit, and the code point formed by the Y bits is used to indicate the maximum number of antenna ports to be measured. Similarly, taking the resource pool grouped according to the code division multiplexing type in Table 1 as an example, the code division multiplexing type is cdm4-FD2-TD2 and nrofPorts=32. Then, according to Table 1, the resource pool where the number of antenna ports to be measured is located is {p32, p24, p16, p12, p8}. Optionally, Y is 3 bits, and each 3 bits code point corresponds to an index in the antenna port set {p32, p24, p16, p12, p8, p4, p2, p1}. For example, the maximum number of antenna ports to be measured corresponding to bit 001 is 2 ports, the maximum number of antenna ports to be measured corresponding to bit 010 is 4 ports, and so on. Optionally, the maximum port number indication bit in the downlink control information is 110, and since the number of antenna ports to be measured obtained according to the Y bit is located in the same resource pool, the set of antenna port numbers to be measured is {p12, p8}.

It should be noted that if the code division multiplexing type is fd-CDM2 and the frequency domain resource allocation configuration is row4, dynamic switching is not performed.

Optionally, the time-frequency domain mapping resources of the channel state information reference signal corresponding to each number of antenna ports in the resource pool are a subset of the time-frequency domain mapping resources of the channel state information reference signal corresponding to the maximum port number in the resource pool.

Optionally, the downlink control information can be specific to the terminal device; may be shared by the terminal devices in a preset group; or may be shared by the terminal devices in a preset cell.

Optionally, when channel state information reference signals with different port numbers have the same non-zero power channel state information reference signal resource identifier, the high-layer parameters of each port number, the first frequency domain resource allocation (frequencyDomainAllocation) and/or the first symbol of the first time domain (firstOFDMSymbolInTimeDomain) and/or the first symbol of the second time domain (firstOFDMSymbolInTimeDomain2) and/or density and/or code division multiplexing type (cdm-type) and/or frequency domain range (freqBand) are configured the same.

Optionally, when channel state information reference signals with different port numbers have the same non-zero power channel state information reference signal resource identifier, the terminal device needs to extract the valid bits in the high-layer parameters firstOFDMSymbolInTimeDomain2, firstOFDMSymbolInTimeDomain, and frequencyDomainAllocation of the channel state information reference signal corresponding to the number of antenna ports according to the second preset rule.

Optionally, when different numbers of channel state information reference signals have different non-zero power channel state information reference signal resource identifiers, each RRC parameter nzp-CSI-RS-ResourceId corresponds to the resource configuration of non-zero power channel state information reference signals for one antenna port number. The RRC parameter nzp-CSI-RS-ResourceId is configured as follows:

NZP-CSI-RS-Resource ::= SEQUENCE {

| | |
|---|---|
| nzp-CSI-RS-ResourceId | NZP-CSI-RS-ResourceId, |
| resourceMapping | CSI-RS-ResourceMapping, |
| powerControlOffset | INTEGER (−8..15), |
| powerControlOffsetSS | ENUMERATED{db−3, db0, db3, db6} OPTIONAL, -- Need R |
| scramblingID | ScramblingId, |
| periodicityAndOffset | CSI-ResourcePeriodicityAndOffset OPTIONAL,- |
| qcl-InfoPeriodicCSI-RS | TCI-StateId OPTIONAL, -- Cond Periodic |

...
}

Optionally, the antenna port numbers corresponding to CSI reference signals with different non-zero-power CSI reference signal resource identifiers are located in the same resource pool. For an example of a resource pool, see Table 1.

It should be noted that Table 1 is only an example of resource pool classification and does not exclude other resource pool classification methods.

Optionally, when channel state information reference signals with different port numbers have different non-zero power channel state information reference signal resource identifiers, the high-layer parameters code division multiplexing type (cdm-Type) and/or density and/or the first symbol of the first time domain (firstOFDMSymbolInTimeDomain) and/or the first symbol of the second time domain (firstOFDMSymbolInTimeDomain 2) and/or the frequency domain range (freqBand) of each port number are configured the same.

Optionally, when channel state information reference signals with different port numbers have different non-zero power channel state information reference signal resource identifiers, the value of the high-layer parameter first frequency domain resource allocation (frequencyDomainAllocation) of the channel state information reference signal corresponding to each nzp-CSI-RS-ResourceId satisfies a preset rule: the positions set to 1 in the first frequency domain resource allocation (frequencyDomainAllocation) of each port number are all a subset of the positions set to 1 in the first frequency domain resource allocation (frequencyDomainAllocation) of the maximum port number in the resource pool where the port number resides.

Optionally, if the code division multiplexing type (cdm-Type) of each antenna port number is configured as fd-CDM2, the maximum port number in the resource pool is 32, and the channel state information reference signal resource identifier nzp-CSI-RS-ResourceId of the 32-port is 0, frequencyDomainAllocation is other, and the bits are 011110, then the higher-layer parameter frequencyDomainAllocation of the channel state information reference signal of 24-port is equal to other and the bit value of frequencyDomainAllocation is a subset of the bits 011110 of the higher-layer parameter frequencyDomainAllocation of the channel state information reference signal of 32-port. Optionally, the bit value for the frequencyDomainAllocation of the 24-port is 011100. Since the channel state information reference signals with different antenna port numbers have different non-zero power channel state information reference signal resource identifiers, the resource identifier nzp-CSI-RS-ResourceId of the 24-port channel state information reference signal is 1. Optionally, the bit values for the frequencyDomainAllocation of the 24-port may also be 010110 or 001110, etc., that is, it is sufficient to ensure that the positions where the frequencyDomainAllocation of the 24-port is set to 1 are a subset of the positions where the frequencyDomainAllocation of the maximum port number (e.g., 32 ports) in the resource pool is set to 1.

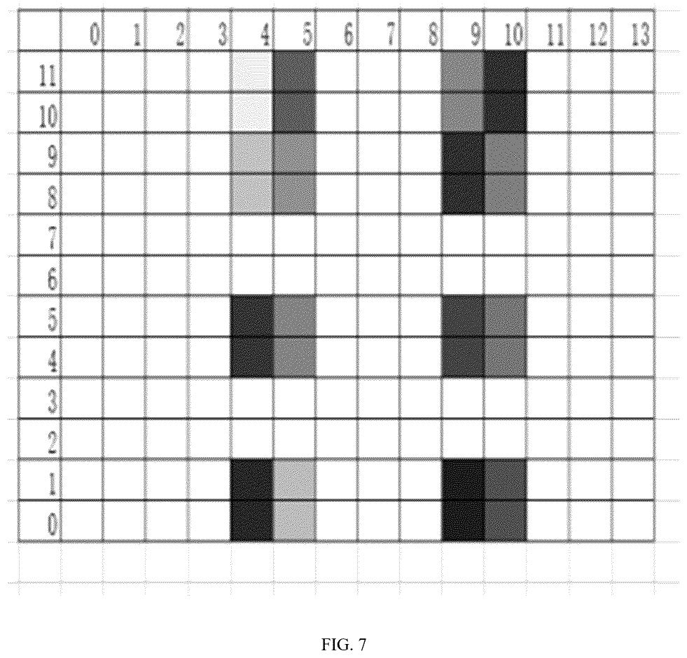

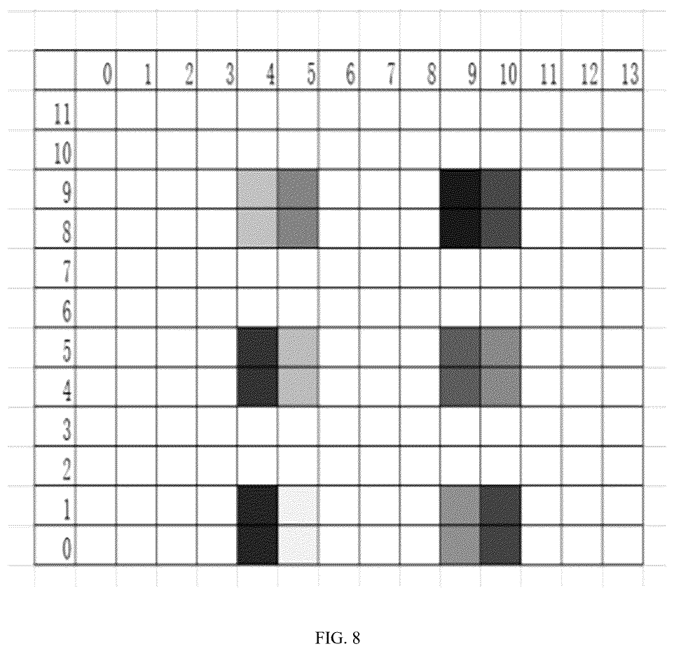

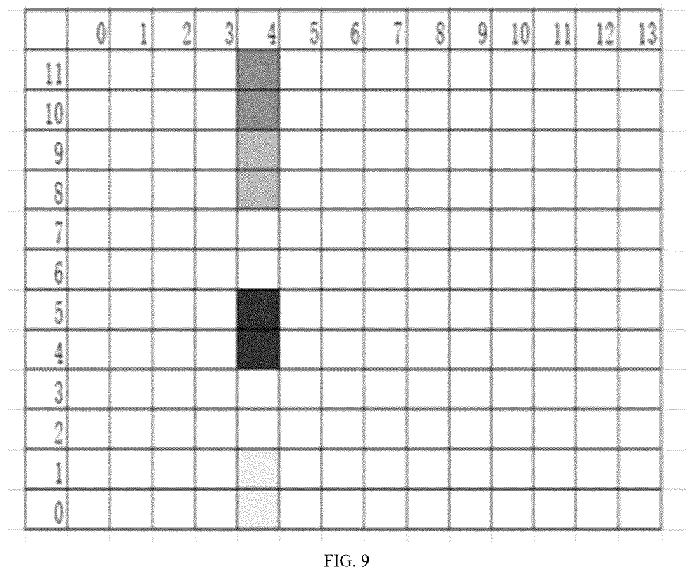

Optionally, when channel state information reference signals with different port numbers have different non-zero power channel state information reference signal resource identifiers, the time-frequency domain resources of the channel state information reference signal determined according to the frequencyDomainAllocation of each port number are multiplexed in the time-frequency domain resource location of the channel state information reference signal of the maximum port number in the resource pool where each port number resides. Optionally, as shown in FIG. 7, FIG. 8, and FIG. 9, FIG. 7 is a first example schematic diagram of the processing method according to the second embodiment, illustrating the time-frequency domain resources occupied by 32 ports; FIG. 8 is a second example schematic diagram of the processing method according to the second embodiment, illustrating the time-frequency domain resources occupied by 24 ports; and FIG. 9 is a third example schematic diagram of the processing method according to the second embodiment, illustrating the time-frequency domain resources occupied by 8 ports. As can be seen, the time-frequency domain resources occupied by 24 ports and 8 ports are both part of the time-frequency domain resources occupied by 32 ports, that is, the channel state information reference signals of 24 ports, 8 ports, and 32 ports multiplex the same time-frequency domain resources.

Optionally, when channel state information reference signals with different port numbers have different non-zero power channel state information reference signal resource set identifiers, each RRC parameter nzp-CSI-ResourceSetId corresponds to the resource configuration of non-zero power channel state information reference signals for one antenna port number. The RRC parameter nzp-CSI-ResourceSetId is configured as follows:

NZP-CSI-RS-ResourceSet ::= SEQUENCE {

| | |
|---|---|
| nzp-CSI-ResourceSetId | NZP-CSI-RS-ResourceSetId, |
| nzp-CSI-RS-Resources | SEQUENCE (SIZE (1..maxNrofNZP-CSI-RS- |

ResourcesPerSet))

| | |
|---|---|
| | OF NZP-CSI-RS-ResourceId, |
| repetition | ENUMERATED { on, off } OPTIONAL, |

aperiodicTriggeringOffset INTEGER(0..4) OPTIONAL,

| | |
|---|---|
| trs-Info | ENUMERATED {true} OPTIONAL, |

```
    ...
  }
```

Optionally, the antenna port numbers corresponding to channel state information reference signals with different non-zero-power channel state information reference signal resource set identifiers are located in the same resource pool. For resource pool examples, see Table 1.

Optionally, when channel state information reference signals with different port numbers have different non-zero-power channel state information reference signal resource set identifiers, the value of the higher-layer parameter frequencyDomainAllocation for the channel state information reference signal corresponding to each nzp-CSI-ResourceSetId satisfies a preset rule: the positions set to 1 in frequencyDomainAllocation for each port number are a subset of the positions set to 1 in frequencyDomainAllocation for the maximum port number in the resource pool where the port number resides.

Optionally, the code division multiplexing type cdm-Type of each antenna port number is configured as fd-CDM2, the maximum port number in the resource pool is 32, and the resource identifier nzp-CSI-ResourceSetId of the channel state information reference signal of the 32-port is 0, frequencyDomainAllocation is other, and the bit is 011110. Then, the high-layer parameter frequencyDomainAllocation of the 24-port channel state information reference signal is other, and the bit value of frequencyDomainAllocation is a subset of the bit 011110 of the high-layer parameter frequencyDomainAllocation of the channel state information reference signal of the 32-port. Optionally, the bit value of frequencyDomainAllocation of the 24-port is 011100. Because CSIs with different antenna port numbers have different non-zero-power CSI-RS resource set identifiers, the CSI-RS resource set identifier for 24 ports, optionally, is nzp-CSI-ResourceSetId=1. Optionally, the bit value of the frequencyDomainAllocation for 24 ports can also be 010110 or 001110, etc., that is, the positions where the frequencyDomainAllocation for 24 ports is set to 1 are a subset of the positions where the frequencyDomainAllocation for the maximum port number in the resource pool (e.g., 32 ports) is set to 1.

In technical solutions of this embodiment, the method includes selecting or determining the port numbers for the channel state information reference signal to be measured based on the downlink information; selecting or determining high-layer parameters corresponding to the channel state information reference signal with at least one group of port numbers that meet preset rules based on the downlink information; and selecting or determining the time domain resource location and/or frequency domain resource location occupied by the channel state information reference signal in the slot based on the high-layer parameters. The port number set of the channel state information reference signal to be measured is dynamically adjusted through downlink information to meet the needs of dynamic antenna port adjustment of network device under different energy-saving requirements; and/or, by multiplexing the same time domain resources and/or frequency domain resources between channel state information reference signals with different antenna port numbers, the interference between channel state information reference signals with different port numbers can be reduced.

### Third Embodiment

Based on any of the above embodiments of the present application, this embodiment further discloses a processing method.

Optionally, when channel state information reference signals with different port numbers have the same non-zero-power channel state information reference signal resource identifier, at least one of the following high-layer parameters of the channel state information reference signals with different port numbers is the same: first frequency domain resource allocation (frequencyDomainAllocation), first symbol of the first time domain (firstOFDMSymbolInTimeDomain), first symbol of the second time domain (firstOFDMSymbolInTimeDomain2), density, code division multiplexing type (cdm-type), and frequency domain range (freqBand).

Optionally, when channel state information reference signals with different port numbers have the same non-zero power channel state information reference signal resource identifier, the first symbol of the first time domain (firstOFDMSymbolInTimeDomain) and/or the first symbol of the second time domain (firstOFDMSymbolInTimeDomain 2) and/or the first frequency domain resource allocation (frequencyDomainAllocation) of the high-layer parameters of the channel state information reference signals with different port numbers, are bit extracted according to the second preset rule.

Optionally, the second preset rule is to determine the number of bits set to 1 in the first frequency domain resource allocation and/or determine whether the first symbol of the second time domain participates in the time domain resource allocation based on Table 7.4.1.5.3-1 of 38.211.

Optionally, when channel state information reference signals with different port numbers have the same non-zero power channel state information reference signal resource identifier, the antenna ports are located in the same resource pool.

Optionally, when channel state information reference signals with different port numbers have the same non-zero power channel state information reference signal resource identifier, the resource pool containing the number of antenna ports to be measured is determined based on at least one of the higher-layer parameters code division multiplexing type (cdm-Type) and port numbers (nrofPorts).

Optionally, the code division multiplexing type cdm-Type=fd-CDM2. If the resource pool partitioning method of Table 1 is adopted, there are two resource pools for the number of antenna ports. If nrofPorts=32, the resource pool is {p32, p24, p16, p8, p4, p2}, and/or, if nrofPorts=24, the resource pool is {p24, p8, p4, p2}.

Optionally, when channel state information reference signals with different port numbers have the same non-zero power channel state information reference signal resource identifier, the high-layer parameter nrofPorts=32, cdm-Type=fd-CDM2, according to Row=16 of Table 7.4.1.5.3-1 of 38.211, the high-layer parameter firstOFDMSymbolInTimeDomain2 of each port number can be configured to 9, firstOFDMSymbolInTimeDomain can be configured to 3, and the number of bits that need to be set to 1 in frequencyDomainAllocation is 4, therefore, it can be configured to 011110.

Optionally, if the set of antenna port numbers to be measured is {p24, p16, p8}, then according to Table 7.4.1.5.3-1 of 38.211, the second rule restriction for each port number is as shown in Table 2. Optionally, according to Table 2, the operation of the high-layer parameter frequencyDomainAllocation of the 24-port that complies with the second preset rule is: only take the first 3 bits set to 1 starting from the least significant bit position, that is, the available bit value of the frequencyDomainAllocation of the 24-port is =001110; the operation of the high-layer parameter frequencyDomainAllocation of the 16-port that complies with the second preset rule is: only take the first 4 bits set to 1 starting from the least significant bit position, that is, the available bit value of the frequencyDomainAllocation of the 16-port is 011110.

Similarly, Table 2 shows that the 8-port high-layer parameter frequencyDomainAllocation complies with the second preset rule by taking only the first four bits set to 1, starting with the least significant bit. That is, the available bits for the 8-port frequencyDomainAllocation are 011110. Regarding the time-domain high-layer parameters firstOFDMSymbolInTimeDomain and/or firstOFDMSymbolInTimeDomain2, Table 2 shows that:
the operation of the 24-port high-layer parameter firstOFDMSymbolInTimeDomain or firstOFDMSymbolInTimeDomain2 that complies with the second preset rule is: firstOFDMSymbolInTimeDomain2=9 and firstOFDMSymbolInTimeDomain=3 can be used at the same time;
the operation of the 16-port high-layer parameter firstOFDMSymbolInTimeDomain or firstOFDMSymbolInTimeDomain2 that complies with the second preset rule is: only the high-layer parameter firstOFDMSymbolInTimeDomain=3 is used, and the high-layer parameter firstOFDMSymbolInTimeDomain2 does not participate in configuring the 16-port CSI-RS resource.

Similarly, the operation of the 8-port high-layer parameter firstOFDMSymbolInTimeDomain and/or firstOFDMSymbolInTimeDomain2 that complies with the second preset rule is: only use the high-layer parameter firstOFDMSymbolInTimeDomain=3, and the high-layer parameter firstOFDMSymbolInTimeDomain2 does not participate in configuring the 8-port CSI-RS resources.

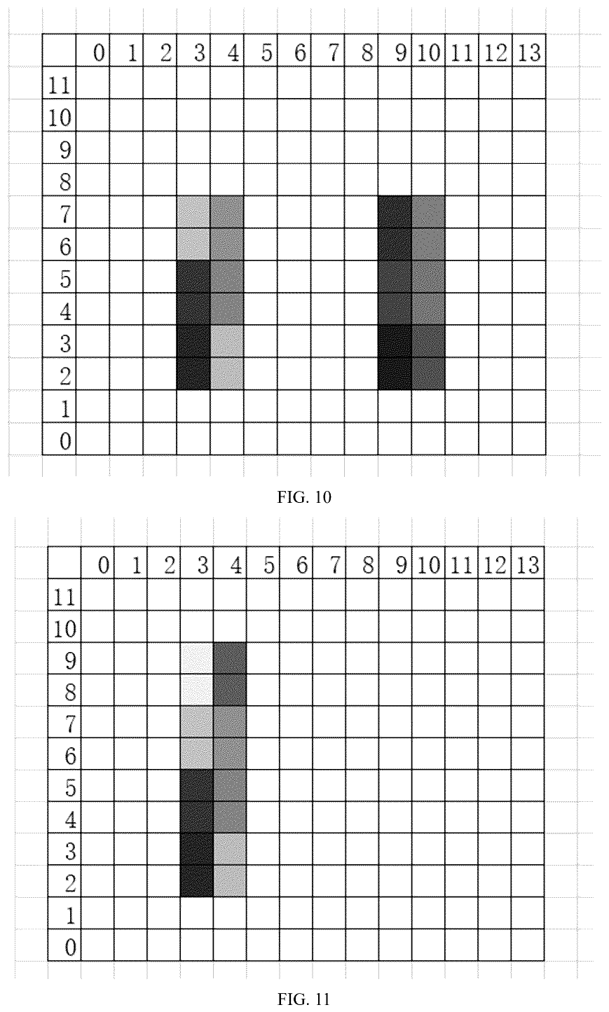

As shown in FIG. 10, FIG. 11 and FIG. 12, FIG. 10 is a first example schematic diagram of the processing method according to the third embodiment, illustrating the time-frequency domain resources occupied by 24 ports in one RB; FIG. 11 is a second example schematic diagram of the processing method according to the third embodiment, illustrating the time-frequency domain resources occupied by 16 ports in one RB; and FIG. 12 is a third example schematic diagram of the processing method according to the third embodiment, illustrating the time-frequency domain resources occupied by 8 ports in one RB.

Alternatively, an example of Table 2 extracted from Table 7.4.1.5.3-1 of 38.211 is as follows:

TABLE 2
Example of second rule restrictions for high-layer parameters with different port numbers

| | Ports | Density | | | CDM group | | |
|---|---|---|---|---|---|---|---|
| Row | X | ρ | cdm-Type | (k̅, l̅) | index j | k′ | l′ |
| 6 | 8 | 1 | fd-CDM2 | (k₀, l₀), (k₁, l₀), (k₂, l₀), (k₃, l₀) | 0, 1, 2, 3 | 0, 1 | 0 |
| 11 | 16 | 1, 0.5 | fd-CDM2 | (k₀, l₀), (k₁, l₀), (k₂, l₀), (k₃, l₀), (k₀, l₀ + 1), | 0, 1, 2, 3, | 0, 1 | 0 |
| | | | | (k₁, l₀ + 1), (k₂, l₀ + 1), (k₃, l₀ + 1) | 4, 5, 6, 7 | | |
| 13 | 24 | 1, 0.5 | fd-CDM2 | (k₀, l₀), (k₁, l₀), (k₂, l₀), (k₀, l₀ + 1), | 0, 1, 2, 3, 4, 5, | 0, 1 | 0 |
| | | | | (k₁, l₀ + 1), (k₂, l₀ + 1), (k₀, l₁), (k₁, l₁), | 6, 7, 8, 9, 10, 11 | | |
| | | | | (k₂, l₁), (k₀, l₁ + 1), (k₁, l₁ + 1), (k₂, l₁ + 1) | | | |
| 16 | 32 | 1, 0.5 | fd-CDM2 | (k₀, l₀), (k₁, l₀), (k₂, l₀), (k₃, l₀), (k₀, l₀ + 1), | 0, 1, 2, 3, | 0, 1 | 0 |
| | | | | (k₁, l₀ + 1), (k₂, l₀ + 1), (k₃, l₀ + 1), (k₀, l₁), | 4, 5, 6, 7, | | |
| | | | | (k₁, l₁), (k₂, l₁), (k₃, l₁), (k₀, l₁ + 1), | 8, 9, 10, 11, | | |
| | | | | (k₁, l₁ + 1), (k₂, l₁ + 1), (k₃, l₁ + 1) | 12, 13, 14, 15 | | |

In above solutions of this embodiment, by assuming that CSI reference signals with different port numbers share the same non-zero-power CSI reference signal resource identifier, no additional RRC parameters or time-frequency domain resources are added. Furthermore, the set of CSI reference signal ports to be measured can be dynamically adjusted using downlink information (such as downlink control information), thereby meeting the dynamic antenna port adjustment requirements of network devices under different energy-saving requirements. Furthermore, CSI reference signals with different antenna port numbers multiplex the same time-frequency domain resources, which can reduce interference between CSI reference signals with different port numbers.

### Fourth Embodiment

Based on any of the above-mentioned embodiments of the present application, this embodiment further discloses a processing method.

Optionally, when CSI reference signals with different port numbers have the same non-zero-power CSI reference signal resource identifier, the set of antenna port numbers to be measured can be selected or determined based on downlink control information.

Optionally, the downlink control information includes an X-bit port number indication bit. For example, if X=8 bits, the bits from Least Significant Bit (LSB) to Most Significant Bit (MSB) correspond to the number of antenna ports p1, p2, p4, p8, p12, p16, p24, and p32, respectively. For example, bits 00101110 indicate that the port numbers of CSI reference signal to be measured is 16, 8, 4, and 2, respectively.

Optionally, when channel state information reference signals with different port numbers have the same non-zero power channel state information reference signal resource identifier, the maximum port number in the set of antenna port numbers to be measured can also be selected or determined based on the downlink control information, and then the set of antenna port numbers to be measured can be selected or determined based on the definition of the resource pool.

Optionally, according to the high-layer parameters code division multiplexing type (cdm-Type)=fd-CDM2 and port numbers (nrofPorts)=32, and the example resource pool in Table 1, it can be known that the resource pool where the set of antenna port numbers to be measured is located is {p32, p24, p16, p8, p4, p2}.

Optionally, the downlink control information includes a Y-bit maximum port number indication bit, and each code point formed by the Y bits corresponds to an index in {p32, p24, p16, p12, p8, p4, p2, p1}, for example, 000 corresponds to p1, that is, the maximum number of antenna ports in the set of antenna port numbers to be measured is 1, 001 corresponds to p2, that is, the maximum number of antenna ports in the set of antenna port numbers to be measured is 2, 010 corresponds to p4, that is, the maximum number of antenna ports in the set of antenna port numbers to be measured is 4, and so on. If maximum port number indication bit with Y bits in the downlink control information is 011, and the resource pool where the set of antenna port numbers to be measured resides is {p32, p24, p16, p8, p4, p2}, the port numbers to be measured is 8 ports, 4 ports, and 2 ports.

In above solutions of this embodiment, by using fewer bits to indicate the measurement resource configuration information of channel state reference signals with different port numbers, when the channel state information reference signals with different port numbers have the same non-zero power channel state information reference signal resource identifier, thereby further saving the overhead of network device.

### Fifth Embodiment

Based on any of the above embodiments of the present application, this embodiment further discloses a processing method.

Optionally, channel state information reference signals with different port numbers have different non-zero power channel state information reference signal resource identifiers, for example, the non-zero power channel state information reference signal resource identifier corresponding to 32 ports is 1, and the non-zero power channel state information reference signal resource identifier corresponding to 24 ports is 3, etc.

Optionally, when channel state information reference signals with different port numbers have different non-zero power channel state information reference signal resource identifiers, at least one of the high-layer parameters of the channel state information reference signals for each port number, including the first symbol of the first time domain (firstOFDMSymbolInTimeDomain), the first symbol of the second time domain (firstOFDMSymbolInTimeDomain 2), density, code division multiplexing type (cdm-type), and frequency domain range (freqBand), is the same.

Optionally, when channel state information reference signals with different port numbers have different non-zero power channel state information reference signal resource identifiers, the positions set to 1 in the higher-layer parameter frequencyDomainAllocation of the channel state information reference signals for each port number is a subset of the positions set to 1 in the higher-layer parameter frequencyDomainAllocation of the channel state information reference signals with the maximum port number in the resource pool.

Optionally, when channel state information reference signals with different port numbers have different non-zero power channel state information reference signal resource identifiers, the number of antenna ports to be measured may be directly specified by an RRC message.

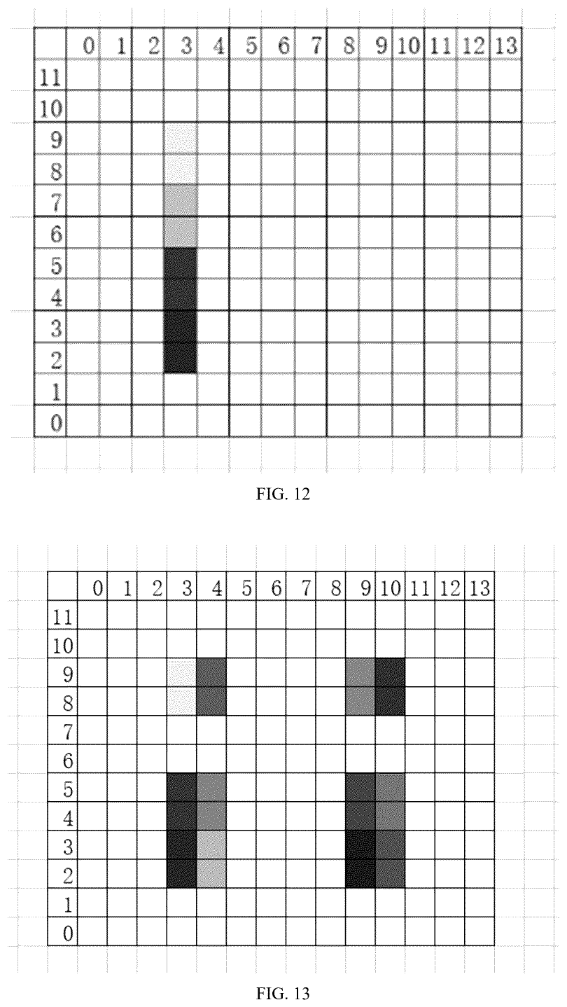

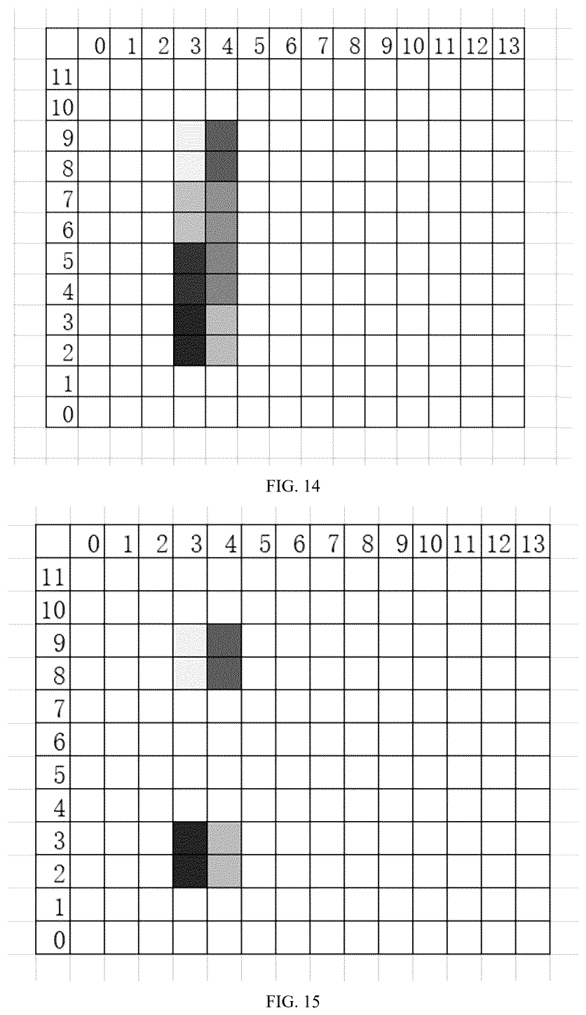

Optionally, if cdm-Type=fd-CDM2 and the resource pool partitioning method of Table 1 is used, the resource pool to which the number of antenna ports to be measured belongs is {p32, p24, p16, p8, p4, p2}. If the RRC message only configures the non-zero-power CSIRS resource identifier for the 4-port CSIRS as 3, the non-zero-power CSIRS resource identifier for the 16-port CSIRS as 5, and the non-zero-power CSIRS resource identifier for the 8-port CSIRS as 6, then the number of antenna ports to be measured is 24, 16, and 8. Since the positions set to 1 in the high-layer parameter frequencyDomainAllocation of the channel state information reference signal for each port number is a subset of the positions set to 1 in the high-layer parameter frequencyDomainAllocation for the maximum port number in the resource pool; and the frequencyDomainAllocation of the maximum port number in the resource pool (32 ports) is 011110, the high-layer parameter frequencyDomainAllocation of the channel state information reference signal for 24 ports can be 010110, the high-layer parameter frequencyDomainAllocation of the channel state information reference signal for 16 ports can be 011110, and the high-layer parameter frequencyDomainAllocation of the channel state information reference signal for 8 ports can be 010010. Therefore, according to Table 7.4.1.5.3-1 of 38.211 and the rules of frequency domain mapping, the time-frequency domain resources occupied by 24 ports in one RB are shown in FIG. 13; referring to FIG. 14, FIG. 14 is a second example schematic diagram of the processing method shown in the fifth embodiment. According to Table 7.4.1.5.3-1 of 38.211 and the rules of frequency domain mapping, the time-frequency domain resources occupied by 16 ports in one RB are shown in FIG. 14; referring to FIG. 15, FIG. 15 is a third example schematic diagram of the processing method shown in the fifth embodiment, and the time-frequency domain resources occupied by 8 ports in one RB are shown in FIG. 15.

Optionally, the value of the higher-layer parameter frequencyDomainAllocation for the channel state information reference signal of each antenna port is a subset of the higher-layer parameter frequencyDomainAllocation for the channel state information reference signal of the maximum port number in the resource pool. For example, taking the maximum port number in the resource pool as 32, and the frequencyDomainAllocation for 32 ports=011110, the higher-layer parameter frequencyDomainAllocation for each port number only needs to be set to a value in a limited number of bit positions that meet the requirements of Table 7.4.1.5.3-1 of 38.211. For example, according to Table 7.4.1.5.3-1 of 38.211, the channel state information reference signal of 24 ports must have three bit positions set to 1. Therefore, the higher-layer parameter frequencyDomainAllocation for the channel state information reference signal of 24 ports can be 010110, 011100, or 001110, etc.

In above solutions of this embodiment, by having different non-zero power channel state information reference signal resource identifiers for channel state information reference signals with different port numbers, the time domain and frequency domain resources of channel state information reference signals with different port numbers are multiplexed, thereby reducing the interference of the time domain and frequency domain resources of channel state information reference signals with different port numbers; and/or, improving the flexibility of mapping the time domain resources and/or frequency domain resources of channel state information reference signals with different port numbers.

### Sixth Embodiment

Based on any of the above embodiments of the present application, this embodiment further discloses a processing method.

Optionally, when channel state information reference signals with different port numbers have different non-zero power channel state information reference signal resource identifiers, the number of antenna ports to be measured can be determined by the downlink control information, and the RRC message includes the time-frequency resource configuration information of the channel state information reference signals for all antenna port numbers in the resource pool.

Optionally, if the code division multiplexing type (cdm-Type) is fd-CDM2, and the resource pool partitioning method of Table 1 is used, and the resource pool is {p32, p24, p16, p8, p4, p2}, then the RRC message includes the time-frequency resource configuration information of the channel state information reference signal for all antenna ports in the resource pool. Optionally, since each antenna port number corresponds to a non-zero power channel state information reference signal resource identifier, the non-zero power channel state information reference signal resource identifier for each antenna port number can be as shown in Table 3:

TABLE 3
First example of RRC configuration of channel state information
reference signals for different ports state

| | |
|---|---|
| NZP-CSI-RS-ResourceId#1 | Resource mapping of 32-port channel state |
| | information reference signal |
| NZP-CSI-RS-ResourceId#2 | Resource mapping of 24-port channel state |
| | information reference signal |
| NZP-CSI-RS-ResourceId#3 | Resource mapping of 16-port channel state |
| | information reference signal |
| NZP-CSI-RS-ResourceId#4 | Resource mapping of 12-port channel state |
| | information reference signal |
| NZP-CSI-RS-ResourceId#5 | Resource mapping of 8-port channel state |
| | information reference signal |
| NZP-CSI-RS-ResourceId#6 | Resource mapping of 4-port channel state |
| | information reference signal |
| NZP-CSI-RS-ResourceId#7 | Resource mapping of 2-port channel state |
| | information reference signal |

Optionally, Table 3 is merely an example of different non-zero-power CSI/RS resource identifiers for different antenna port numbers. The CSU/RS resource identifiers for different port numbers can be configured by RRC based on specific circumstances.

Optionally, the resource pool where each port number resides is determined based on the code division multiplexing type (cdm-Type) and the RRC message.

Optionally, when CSU/RS resource identifiers for different port numbers are different, the set of antenna port numbers to be measured can be selected or determined based on downlink control information.

Optionally, the downlink control information contains an X-bit port number indication bit. According to the code division multiplexing type (cdm-Type) and RRC configuration, the resource pool is {32, 24, 16, 8, 4, 2}. Taking X=8 bits as an example, from the LSB bit to the MSB bit, they correspond to the number of antenna ports p1, p2, p4, p8, p12, p16, p24, and p32 respectively. For example, bit 00101110 indicates that the port numbers of CSI reference signal to be measured is 16, 8, 4, and 2 respectively.

Optionally, the downlink control information contains a Y-bit maximum port number indication bit, and each Y-bit code point corresponds to an index in {p32, p24, p16, p12, p8, p4, p2, p1}. Taking Y=3 bits as an example, 000 corresponds to the maximum port number p1, meaning the maximum number of antenna ports in the set to be measured is 1, 001 corresponds to the maximum port number p2, meaning the maximum number of antenna ports in the set to be measured is 2, 010 corresponds to the maximum port number p4, meaning the maximum number of antenna ports in the set to be measured is 4, and so on. If the resource pool for the number of antenna ports to be measured is {p32, p24, p16, p8, p4, p2}, and the “maximum port numbers” bit in the DCI is 011, then the port numbers to be measured is 8, 4, and 2.

In above solutions of this embodiment, by configuring the time domain and frequency domain resources of the channel state information reference signal for all possible ports in the RRC message, and indicating the port set of the channel state information reference signal that currently needs to be measured through DCI, the flexibility of dynamically adjusting the port numbers for the channel state information reference signal is further improved.

### Seventh Embodiment

Based on any of the above embodiments of the present application, this embodiment further discloses a processing method.

Optionally, channel state information reference signals with different port numbers have different non-zero power channel state information reference signal resource set identifiers, for example, the non-zero power channel state information reference signal resource set identifier corresponding to 32 ports is 1, and the non-zero power channel state information reference signal resource set identifier corresponding to 24 ports is 3, etc.

Optionally, when channel state information reference signals with different port numbers have different non-zero power channel state information reference signal resource identifiers, at least one of the high-layer parameters of the channel state information reference signals for each port number, including the first symbol of the first time domain (firstOFDMSymbolInTimeDomain), the first symbol of the second time domain (firstOFDMSymbolInTimeDomain 2), density, code division multiplexing type (cdm-type), and frequency domain range (freqBand), is the same.

Optionally, when channel state information reference signals with different port numbers have different non-zero power channel state information reference signal resource set identifiers, the positions set to 1 in the high-layer parameter frequencyDomainAllocation of the channel state information reference signal for each port number need to be a subset of the positions set to 1 in the high-layer parameter frequencyDomainAllocation of the maximum port number in the resource pool.

Optionally, if cdm-Type=fd-CDM2, and the resource pool partitioning method of Table 1 is used, the resource pool to which the number of antenna ports to be measured belongs is {p32, p24, p16, p8, p4, p2}. Optionally, since the position in which the higher-layer parameter frequencyDomainAllocation of the channel state information reference signal for each port is set to 1 is a subset of the higher-layer parameter frequencyDomainAllocation of the channel state information reference signal for the maximum port number in the resource pool, taking the maximum port number in the resource pool is 32 and the frequencyDomainAllocation of 32 ports is 011110 as an example, the higher-layer parameter frequencyDomainAllocation of each port number needs to be configured in a position that satisfies the limited number of bits in Table 7.4.1.5.3-1 of 38.211 and the frequencyDomainAllocation of 32 ports is set to 1. Optionally, the number of antenna ports of the channel state information reference signal to be measured is 24, 16, and 8; and the non-zero power channel state information reference signal resource set identifier of the 24-port channel state information reference signal obtained according to the RRC message is 3, the non-zero power channel state information reference signal resource set identifier of the 16-port channel state information reference signal is 5, and the non-zero power channel state information reference signal resource set identifier of the 8-port channel state information reference signal is 6. The value of frequencyDomainAllocation of the 24-port channel state information reference signal can be 010110. The value of frequencyDomainAllocation of the 16-port channel state information reference signal can be 011110, and the value of frequencyDomainAllocation of the 8-port channel state information reference signal can be 010010. According to Table 7.4.1.5.3-1 of 38.211 and the frequency domain mapping rules, the time-frequency domain resources occupied by the 24-port in one RB are shown in FIG. 13. According to Table 7.4.1.5.3-1 of 38.211 and the frequency domain mapping rules, the time-frequency domain resources occupied by 16 ports in one RB are shown in FIG. 14; the time-frequency domain resources occupied by 8 ports in one RB are shown in FIG. 15. Optionally, taking 24-port as an example, the higher-layer parameter frequencyDomainAllocation of the channel state information reference signal for 24-port may also be 010110, 011100, or 001110, etc. That is, according to Table 7.4.1.5.3-1 of 38.211, the channel state information reference signal of 24-port only needs to select the three bit positions set to 1 in the higher-layer parameter frequencyDomainAllocation of 32-port.

In above solutions of this embodiment, by having different non-zero power channel state information reference signal resource set identifiers for channel state information reference signals with different port numbers, the time domain and frequency domain resources of channel state information reference signals with different port numbers can be multiplexed, thereby reducing the interference of the time domain and frequency domain resources of channel state information reference signals with different port numbers; and/or, the flexibility of time domain and frequency domain resource mapping of channel state information reference signals with different port numbers can be improved.

### Eighth Embodiment

Based on any of the above embodiments of the present application, this embodiment further discloses a processing method.

Optionally, when channel state information reference signals with different port numbers have different non-zero-power channel state information reference signal resource set identifiers, the number of antenna ports to be measured can be directly specified by an RRC message.

Optionally, if cdm-Type=fd-CDM2 and the resource pool partitioning method of Table 1 is used, the resource pool to which the number of antenna ports to be measured belongs is {p32, p24, p16, p8, p4, p2}. If the RRC message only configures the non-zero power channel state information reference signal resource set identifier of the 4-port channel state information reference signal as 3, the non-zero power channel state information reference signal resource set identifier of the 16-port channel state information reference signal as 5, and the non-zero power channel state information reference signal resource set identifier of the 8-port channel state information reference signal as 6, then the number of antenna ports to be measured is 24, 16 and 8.

Optionally, when the non-zero power channel state information reference signal resource set identifiers of the channel state information reference signals for different ports are used, the number of antenna ports to be measured can be determined by the downlink control information, and the RRC message includes the time-frequency resource configuration information of the channel state information reference signals for all antenna ports in the resource pool.

Optionally, the code division multiplexing type (cdm-Type)=fd-CDM2. If the resource pool partitioning method of Table 1 is used, and the resource pool is {p32, p24, p16, p8, p4, p2}, then the RRC message includes the time-frequency resource configuration information of the channel state information reference signal for all antenna ports in the resource pool. Optionally, since each antenna port number has a non-zero power channel state information reference signal resource set identifier, the non-zero power channel state information reference signal resource set identifier for each antenna port number can be as shown in Table 4:

TABLE 4
Second example table of RRC configuration of channel state
information reference signals for different ports

| | |
|---|---|
| NZP-CSI-RS-ResourceSetId#1 | Resource mapping of 32-port channel |
| | state information reference signal |
| NZP-CSI-RS-ResourceSetId#2 | Resource mapping of 24-port channel |
| | state information reference signal |
| NZP-CSI-RS-ResourceSetId#3 | Resource mapping of 16-port channel |
| | state information reference signal |
| NZP-CSI-RS-ResourceSetId#4 | Resource mapping of 12-port channel |
| | state information reference signal |
| NZP-CSI-RS-ResourceSetId#5 | Resource mapping of 8-port channel |
| | state information reference signal |
| NZP-CSI-RS-ResourceSetId#6 | Resource mapping of 4-port channel |
| | state information reference signal |
| NZP-CSI-RS-ResourceSetId#7 | Resource mapping of 2-port channel |
| | state information reference signal |

Optionally, Table 4 is only an example of different non-zero-power channel state information reference signal resource set identifiers for different antenna port numbers. The resource set identifiers of channel state information reference signals with different port numbers can be configured by RRC according to specific circumstances.

Optionally, when channel state information reference signals with different port numbers have different non-zero-power channel state information reference signal resource set identifiers, the number set of antenna ports to be measured can be selected or determined according to downlink control information.

Optionally, the resource pool where each port number resides is determined based on the code division multiplexing type (cdm-Type) and RRC message.

Optionally, the downlink control information contains an X-bit port number indication bit. According to the code division multiplexing type (cdm-Type) and RRC configuration, the resource pool is {p32, p24, p16, p8, p4, p2}. Taking X=8 bits as an example, from the LSB bit to the MSB bit, they correspond to the number of antenna ports p1, p2, p4, p8, p12, p16, p24, and p32 respectively. For example, bit 00101110 indicates that the port numbers of CSI reference signal to be measured is 16, 8, 4, and 2 respectively.

Optionally, the downlink control information includes a Y-bit maximum port number indication bit, and each code point formed by the Y bits corresponds to an index in {p32, p24, p16, p12, p8, p4, p2, p1}. Taking Y=3 bits as an example, 000 corresponds to the maximum port number p1, that is, the maximum number of antenna ports in the set of antenna port numbers to be measured is 1, 001 corresponds to the maximum port number p2, that is, the maximum number of antenna ports in the set of antenna port numbers to be measured is 2, 010 corresponds to the maximum port number p4, that is, the maximum number of antenna ports in the set of antenna port numbers to be measured is 4, and so on. If the resource pool for the number of antenna ports to be measured is {p32, p24, p16, p8, p4, p2}, and if the “maximum port numbers” bits in the DCI are 011, the port numbers to be measured is 8, 4, and 2.

In above solutions of this embodiment, by configuring the time domain resources and/or frequency domain resources of the channel state information reference signal of all possible ports at one time in the RRC message, and indicating the port set of the channel state information reference signal that currently needs to be measured through DCI, the flexibility of dynamically adjusting the port numbers for the channel state information reference signal is further improved.

### Ninth Embodiment

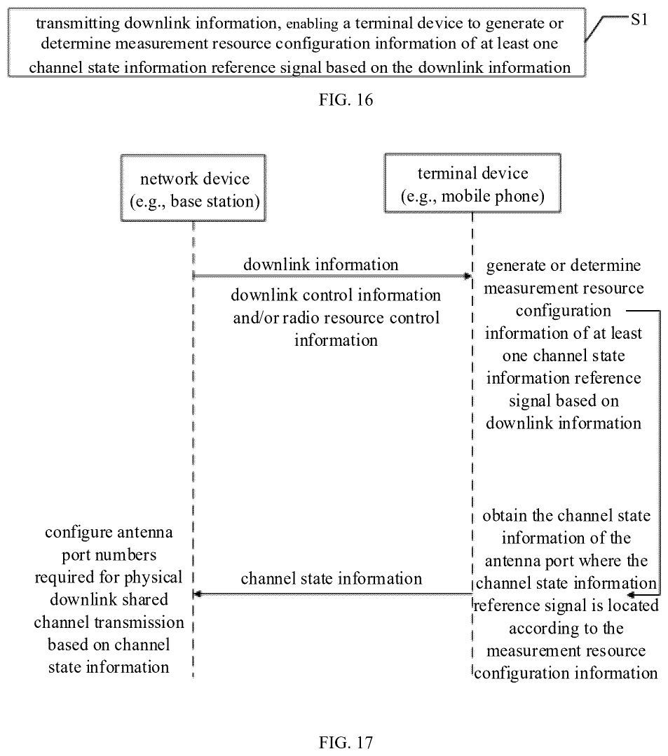

Referring to FIG. 16, FIG. 16 is a flowchart illustrating a processing method according to the ninth embodiment, the method according to this embodiment of the present application can be applied to a network device (e.g., a base station) and includes the following steps:

S1: transmitting downlink information so that a terminal device generates or determines measurement resource configuration information of at least one channel state information reference signal based on the downlink information.

Optionally, the network device transmits the downlink information to the terminal device, so that the terminal device generates or determines measurement resource configuration information of at least one channel state information reference signal based on the downlink information.

Optionally, the downlink information is downlink control information and/or radio resource control information.

Optionally, the downlink information can be specific to each terminal device, can be shared by the terminal devices in a preset group, or can be shared by all terminal devices within a preset cell.

Optionally, terminal devices belonging to the same preset group must have the same quality of service requirements, such as transmission code block size and transmission rate.

Optionally, the reference signal received power of terminal devices belonging to the same preset group is greater than a first preset threshold and not exceed a second preset threshold.

Optionally, DCI can be configured for a group of terminal devices or for all terminal devices in a cell. If it is placed in the same DCI as the CSI reporting trigger indication, the DCI can be terminal device specific.

Optionally, the channel state information reference signal is a non-zero-power channel state information reference signal and/or a zero-power channel state information reference signal.

Optionally, the channel state information is at least one of a channel quality indicator, a precoding matrix indicator, a channel state information reference signal resource indicator, a layer indicator, a rank indicator, a layer 1 reference signal reception quality, and a layer 1 signal-to-noise ratio.

Optionally, after receiving downlink control information and/or radio resource control information, the terminal device may determine the port numbers for channel state information reference signals with different port numbers based on the downlink control information and/or radio resource control information, and determine measurement resource configuration information in combination with higher-layer parameters that meet preset rules.

Optionally, the measurement resource configuration information of the channel state information reference signals with different port numbers includes the time domain resource location and frequency domain resource location occupied by the channel state information reference signals in the slot in which they are located.

Optionally, channel state information reference signals with different port numbers may have the same or different non-zero-power channel state information reference signal resource identifiers; channel state information reference signals with different port numbers may also have different non-zero-power channel state information reference signal resource set identifiers.

Optionally, after the terminal device generates or determines measurement resource configuration information of at least one channel state information reference signal based on the downlink information, it may obtain channel state information for the antenna port where the channel state information reference signal is transmitted based on the measurement resource configuration information.

Optionally, after the network device receives channel state information of different antenna ports reported by the terminal device, it may configure the number of antenna ports required for physical downlink shared channel transmission based on the channel state information.

In above solutions of this embodiment, by transmitting downlink information, the terminal device generates or determines the measurement resource configuration information of at least one channel state information reference signal based on the downlink information, and provides a scheme for generating or determining the measurement resource configuration information that can support dynamic adjustment of antenna ports, which is used to dynamically obtain the channel state information of each antenna port so as to support network device to dynamically adjust the antenna port and/or reduce the energy consumption of the network device.

### Tenth Embodiment

Referring to FIG. 17, FIG. 17 is a schematic diagram illustrating an interaction sequence according to the tenth embodiment. Based on the aforementioned embodiments of the present application, this embodiment further discloses the processing methods of the aforementioned embodiments.

In this embodiment of the present application, a network device (e.g., a base station) transmits downlink information to a terminal device (e.g., a mobile phone).

Optionally, the network device transmits the downlink information to the terminal device, enabling the terminal device to generate or determine measurement resource configuration information of at least one channel state information reference signal based on the downlink information.

Optionally, the downlink information transmitted by the network device includes downlink control information and/or radio resource control information.

Optionally, the network device transmits RRC parameters for channel state information reference signals configured with different port numbers to the terminal device, and/or transmits DCI to the terminal device containing a set of port numbers to be measured.

Optionally, the downlink information can be specific to each terminal device, can be shared by terminal devices within a predefined group, or can be shared by all terminal devices within a predefined cell.

Optionally, terminal devices belonging to the same predefined group must have the same quality of service requirements, such as transmission code block size and transmission rate.

Optionally, the reference signal received power of terminal devices belonging to the same predefined group is greater than a first preset threshold and not exceed a second preset threshold.

Optionally, DCI can be configured for a group of terminal devices or for all terminal devices in a cell. If it is placed in the same DCI as the CSI reporting trigger indication, the DCI can be terminal device specific.

Optionally, the channel state information reference signal is a non-zero-power channel state information reference signal and/or a zero-power channel state information reference signal.

Optionally, the channel state information is at least one of a channel quality indicator, a precoding matrix indicator, a channel state information reference signal resource indicator, a layer indicator, a rank indicator, a layer 1 reference signal reception quality, and a layer 1 signal-to-noise ratio.

Optionally, after receiving the downlink control information and/or radio resource control information, the terminal device can determine the port number of the channel state information reference signal with different port numbers based on the downlink control information and/or radio resource control information, and determine the measurement resource configuration information in combination with the high-layer parameters that meet the preset rules.

Optionally, the terminal device selects and determines the RRC parameters of the channel state information reference signal for the number of antenna ports to be measured according to the set of the number of antenna ports to be measured indicated by the DCI.

Optionally, the terminal device performs channel state information measurement based on the measurement resource configuration information of the channel state information reference signals for the number of antenna ports to be measured.

Optionally, channel state information reference signals for different port numbers may have the same or different non-zero-power channel state information reference signal resource identifiers; channel state information reference signals for different port numbers may also have different non-zero-power channel state information reference signal resource set identifiers.

Optionally, the measurement resource configuration information of the channel state information reference signal with different port numbers determined by the terminal device includes the time domain resource location and frequency domain resource location occupied by the channel state information reference signal in the slot in which it is located.

Optionally, after the terminal device generates or determines measurement resource configuration information of at least one channel state information reference signal based on the downlink information, it can obtain channel state information for the antenna port where the channel state information reference signal is located based on the measurement resource configuration information.

Optionally, the terminal device generates or determines a channel state information report and reports it to the network device.

Optionally, after receiving the channel state information of different antenna ports reported by the terminal device, the network device can configure the number of antenna ports required for physical downlink shared channel transmission based on the channel state information.

In above solutions of this embodiment, the network device sends downlink information to the terminal device, so that the terminal device generates or determines the measurement resource configuration information of at least one channel state information reference signal based on the downlink information, and realizes the dynamic adaptive configuration and indication of antenna port numbers within the same resource set in different types of channel state information reports, or within a limited number of channel measurement reports, so as to meet the needs of dynamic antenna port adjustment of the network device under different energy-saving requirements, and better realize energy saving for the network device.

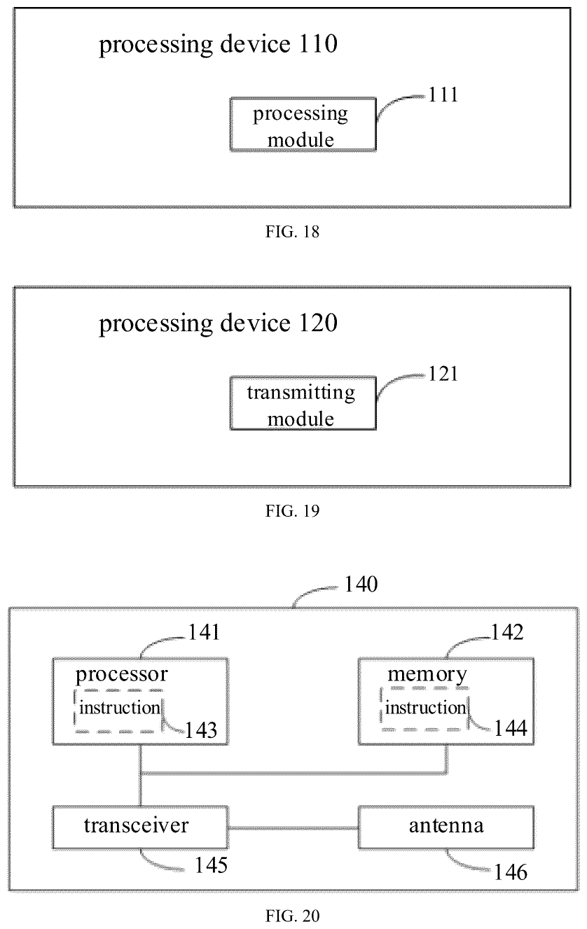

As shown in FIG. 18, FIG. 18 is a schematic structural diagram of a processing device provided in an embodiment of the present application. The device can be installed in or is the terminal device in the above-mentioned method embodiment. The processing device shown in FIG. 18 can be used to perform some or all of the functions in the method embodiment described in the above embodiment. As shown in FIG. 18, the processing device 110 includes a processing module 111.

The processing module 111 is configured to generate or determine measurement resource configuration information of at least one channel state information reference signal based on downlink information.

Optionally, generating or determining measurement resource configuration information of at least one channel state information reference signal based on downlink information includes:
selecting or determining, based on the downlink information, the port numbers for the channel state information reference signal to be measured;
selecting or determining, based on the downlink information, higher-layer parameters for at least one group of channel state information reference signals with a certain port numbers that meet a preset rule;
selecting or determining, based on the higher-layer parameters, the time domain resource location and/or frequency domain resource location occupied by the channel state information reference signal in the slot.

Optionally, the meeting the preset rule includes at least one of the following:
at least one of the first frequency domain resource allocation, the first symbol of the first time domain, and the first symbol of the second time domain in the higher-layer parameters of the channel state information reference signals with different port numbers is the same;
the first frequency domain resource allocation in the higher-layer parameters of the channel state information reference signals with different port numbers is a subset of the first frequency domain resource allocation in the higher-layer parameters of the channel state information reference signal with the maximum port number in the resource pool where the port numbers resides.

Optionally, selecting or determining at least one group of channel state information reference signal ports based on downlink information includes at least one of the following:
determining the port numbers of at least one group of non-zero-power channel state information reference signals to be measured based on different bits in a first bit field of the downlink control information;
determining the maximum port number of non-zero-power channel state information reference signals to be measured based on a code point formed by all bits in a second bit field of the downlink control information, and selecting or determining the port numbers of at least one group of non-zero-power channel state information reference signals to be measured based on the maximum port number.

Optionally, the device further includes at least one of the following:
channel state information reference signals with different port numbers are located in the same code division multiplexing group and/or the same resource pool;
channel state information reference signals with different port numbers have the same or different non-zero power channel state information reference signal resource identifiers;
channel state information reference signals with different port numbers have different non-zero power channel state information reference signal resource set identifiers.

Optionally, the device further includes:
obtaining channel state information for the antenna port where the channel state information reference signal is located based on measurement resource configuration information.

Optionally, the device further includes at least one of the following:
the downlink information is downlink control information and/or radio resource control information;
the channel state information reference signal is a non-zero-power channel state information reference signal and/or a zero-power channel state information reference signal;
the channel state information is at least one of a channel quality indicator, a precoding matrix indicator, a channel state information reference signal resource indicator, a layer indicator, a rank indicator, a layer 1 reference signal reception quality, and a layer 1 signal-to-noise ratio.

Optionally, the device further includes at least one of the following:
the downlink information is specific to each terminal device;
the downlink information is shared by the terminal devices in a preset group;
the downlink information is shared by all terminal devices within a preset cell.

Optionally, the device further includes at least one of the following:
terminal devices belonging to the same preset group must have the same quality of service requirements;
the reference signal received power of terminal devices belonging to the same preset group is greater than a first preset threshold and does not exceed a second preset threshold.

The processing device provided in the embodiment of the present application can execute the technical solution shown in the above method embodiment. Its implementation principle and beneficial effects are similar and will not be repeated here.

As shown in FIG. 19, FIG. 19 is a second structural diagram of a processing device according to an embodiment of the present application. This device may be implemented in or be the network device in the aforementioned method embodiment. As shown in FIG. 19, the processing device 120 includes a transmitting module 121.

The transmitting module 121 is configured to transmit downlink information, enabling a terminal device to generate or determine measurement resource configuration information of at least one channel state information reference signal based on the downlink information.

Optionally, the device includes at least one of the following:
the downlink information is specific to each terminal device;
the downlink information is shared by the terminal devices in a preset group;
the downlink information is shared by all terminal devices within a preset cell.

Optionally, the device further includes at least one of the following:
terminal devices belonging to the same preset group must have the same quality of service requirements;
the reference signal received power of terminal devices belonging to the same preset group is greater than a first preset threshold and less than a second preset threshold.

Optionally, the device further includes:
configuring the number of antenna ports required for transmission on the physical downlink shared channel based on channel state information.

The processing device provided in the embodiments of the present application can implement the technical solutions described in the above method embodiments. The implementation principles and beneficial effects are similar and are not further described here.

As shown in FIG. 20, FIG. 20 is a schematic structural diagram of a communication device provided in an embodiment of the present application. As shown in FIG. 20, the communication device 140 described in this embodiment can be the terminal device (or a component that can be used for a terminal device) or the network device (or a component that can be used for a network device) mentioned in the aforementioned method embodiments. The communication device 140 can be used to implement the methods described in the aforementioned method embodiments corresponding to the terminal device or network device. For details, please refer to the description of the aforementioned method embodiments.

The communication device 140 may include one or more processors 141, also referred to as processing units, which may perform certain control or processing functions. The processor 141 may be a general-purpose processor or a dedicated processor. For example, it may be a baseband processor or a central processing unit. The baseband processor may be used to process communication protocols and communication data, while the central processing unit may be used to control the communication device, execute software programs, and process software program data.

Optionally, the processor 141 may also store instructions 143 or data (e.g., intermediate data). Optionally, the instructions 143 may be executed by the processor 141, causing the communication device 140 to perform the methods described in the aforementioned method embodiments corresponding to a terminal device or network device.

Optionally, the communication device 140 may include circuitry that implements the sending, receiving, or communication functions described in the aforementioned method embodiments.

Optionally, the communication device 140 may include one or more memories 142, which may store instructions 144. These instructions may be executed by the processor 141, causing the communication device 140 to perform the methods described in the aforementioned method embodiments.

Optionally, the memory 142 may also store data. The processor 141 and the memory 142 may be provided separately or integrated.

Optionally, the communication device 140 may further include a transceiver 145 and/or an antenna 146. The processor 141 may be referred to as a processing unit, which controls the communication device 140 (terminal device, core network device, or wireless access network device). The transceiver 145 may be referred to as a transceiver unit, transceiver, transceiver circuit, or transceiver, etc., and is used to implement the transceiver functions of communication device 140.

Optionally, if the communication device 140 is configured to implement operations corresponding to the terminal device described in the aforementioned embodiments, for example, the transceiver 145 may transmit channel state information; and the processor 141 may generate or determine measurement resource configuration information of at least one channel state information reference signal based on the downlink information.

Optionally, the specific implementation of the processor 141 and the transceiver 145 can be found in the description of the aforementioned embodiments and will not be further elaborated here.

Optionally, if the communication device 140 is configured to implement operations corresponding to the network device described in the aforementioned embodiments, for example, the transceiver 145 may transmit downlink information, enabling the terminal device to generate or determine measurement resource configuration information of at least one channel state information reference signal based on the downlink information.

Optionally, the specific implementation of the processor 141 and the transceiver 145 can be found in the description of the aforementioned embodiments and will not be further elaborated here.

The processor 141 and the transceiver 145 described in the present application can be implemented on an Integrated Circuit (IC), an analog integrated circuit, a Radio Frequency Integrated Circuit (RFIC), a mixed-signal integrated circuit, an Application Specific Integrated Circuit (ASIC), a Printed Circuit Board (PCB), an electronic device, etc. The processor 141 and the transceiver 145 may also be manufactured using various integrated circuit process technologies, such as Complementary Metal Oxide Semiconductor (CMOS), N Metal-Oxide-Semiconductor (NMOS), Positive channel Metal Oxide Semiconductor (PMOS), Bipolar Junction Transistor (BJT), bipolar CMOS (BiCMOS), silicon germanium (SiGe), gallium arsenide (GaAs), etc.

In the present application, a communication device may be a terminal device (such as a mobile phone) or a network device (such as a base station), and the specific definition needs to be determined based on the context. In addition, the terminal device can be implemented in various forms. For example, the terminal devices described in the present application may include mobile terminals such as mobile phones, tablet computers, laptop computers, PDAs, portable media players (PMPs), navigation devices, wearable devices, smart bracelets, pedometers, etc., as well as fixed terminal devices such as digital TVs and desktop computers.

Although the communication device is described above by taking a terminal device or a network device as an example, the scope of the communication device described in this application is not limited to the above-mentioned terminal device or network device, and the structure of the communication device may not be limited to FIG. 20. The communication device may be an independent device or may be part of a larger device.

An embodiment of the present application also provides a communication system, including a terminal device as described in any of the above method embodiments; and a network device as described in any of the above method embodiments.

An embodiment of the present application also provides a communication device, including a memory and a processor, the memory stores a processing program, and when the processing program is executed by the processor, the steps of the processing method described in any of the above embodiments are implemented.

The communication device in the present application can be a terminal device (such as a mobile phone) or a network device (such as a base station), and the specific reference should be clarified based on the context.

The present application also provides a storage medium storing a processing program. When executed by a processor, the processing program implements the steps of any of the processing methods described in the aforementioned embodiments.

The communication device and the storage medium provided in the present application may include all of the technical features of any of the aforementioned processing method embodiments. The expanded description and explanations are essentially the same as those in the aforementioned method embodiments and are not further elaborated here.

The present application also provides a computer program product including a computer program code. When the computer program code is executed on a computer, the computer executes the methods described in the various possible embodiments.

The present application also provides a chip including a memory and a processor. The memory is configured to store a computer program, and the processor is configured to retrieve and execute the computer program from the memory, thereby causing a device equipped with the chip to execute the methods described in the various possible embodiments.

It can be understood that the above-mentioned scenarios are only examples and do not constitute a limitation on the application scenarios of the technical solutions provided in the embodiments of the present application. The technical solutions of the present application can also be applied to other scenarios. For example, it is known to ordinary technicians in the field that with the evolution of the system architecture and the emergence of new business scenarios, the technical solutions provided in the embodiments of the present application are also applicable to similar technical problems.

The serial numbers of the embodiments of the present application are for description only and do not represent the advantages and disadvantages of the embodiments.

The steps in the method of the embodiment of the present application can be adjusted in order, merged and deleted according to actual needs.

The units in the device of the embodiment of the present application can be merged, divided and deleted according to actual needs.

In the present application, the same or similar terminology, technical solution and/or application scenario description is generally described in detail only when it appears for the first time. When it appears again later, it is generally not repeated for the sake of brevity. When understanding the technical solution and other contents of the present application, for the same or similar terminology, technical solution and/or application scenario description that is not described in detail later, please refer to the previous related detailed description.

In the present application, the descriptions of various embodiments have different focuses. For parts that are not described or denoted in a certain embodiment, please refer to the relevant descriptions of other embodiments.

The various technical features of the technical solution of the present application can be combined arbitrarily. In order to make the description concise, all possible combinations of the various technical features in the above embodiments are not described. However, as long as there is no contradiction in the combination of these technical features, they should be considered to fall within the scope of the present application.

Through the above description of the implementation, those skilled in the art can clearly understand that the above embodiment methods can be implemented by software plus the necessary general hardware platform, or by hardware, but in many cases the former is a better implementation. Based on this understanding, the technical solution of the present application essentially or the part that contributes to the existing technology can be embodied in the form of a software product, and the computer software product is stored in one of the above storage media (such as ROM/RAM, disk, optical disk), including several instructions to cause a terminal device (which can be a mobile phone, a computer, a server, a controlled terminal, or a network device, etc.) to execute the method of each embodiment of the present application.

The above embodiments can be implemented in whole or in part by software, hardware, firmware or any combination thereof. When implemented by software, it can be implemented in whole or in part in the form of a computer program product. The computer program product includes one or more computer instructions. When the computer program instructions are loaded and executed on the computer, the process or function according to the embodiment of the present application is generated in whole or in part. The computer can be a general-purpose computer, a special-purpose computer, a computer network, or other programmable device. The computer instructions can be stored in a computer-readable storage medium, or transmitted from one computer-readable storage medium to another computer-readable storage medium. For example, the computer instructions can be transmitted from one website, computer, server or data center to another website, computer, server or data center by wired (such as coaxial cable, optical fiber, digital subscriber line (DSL)) or wireless (such as infrared, wireless, microwave, etc.) means. The computer-readable storage medium can be any available medium that can be accessed by the computer or a data storage device such as a server or data center that includes one or more available media integrated. The available medium can be a magnetic medium (such as a floppy disk, a storage disk, a tape), an optical medium (such as a DVD), or a semiconductor medium (such as a Solid State Disk (SSD)), etc.

The above are only some embodiments of the present application, and are not intended to limit the scope of the present application. Any equivalent structure or equivalent process transformation made using the contents of the specification and drawings of the present application, or directly or indirectly applied in other related technical fields, shall be similarly included in the scope of the present application.

What is claimed is:

1. A processing method, comprising:
generating or determining measurement resource configuration information of at least one channel state information reference signal based on downlink information.

2. The method according to claim 1, wherein the generating or determining the measurement resource configuration information of at least one channel state information reference signal based on the downlink information comprises:
selecting or determining, based on the downlink information, the port numbers for a channel state information reference signal to be measured;
selecting or determining, based on the downlink information, higher-layer parameters for at least one group of channel state information reference signals with a certain port numbers that meet a preset rule; and
selecting or determining, based on the higher-layer parameters, a time domain resource location and/or a frequency domain resource location occupied by the channel state information reference signal in a slot.

3. The method according to claim 2, wherein the meeting the preset rule comprises at least one of the following:
at least one of a density, a code division multiplexing type, and a frequency domain range in the high-layer parameters of the channel state information reference signals with different port numbers is the same;
at least one of a first frequency domain resource allocation, a first symbol of a first time domain, and a first symbol of a second time domain in the higher-layer parameters of the channel state information reference signals with different port numbers is the same; and
the first frequency domain resource allocation in the higher-layer parameters of the channel state information reference signals with different port numbers is a subset of the first frequency domain resource allocation in the higher-layer parameters of the channel state information reference signal with the maximum port number in a resource pool where the port number resides.

4. The method according to claim 2, wherein the selecting or determining, based on the downlink information, the port numbers for the channel state information reference signal to be measured comprises at least one of the following:
determining the port numbers of at least one group of non-zero-power channel state information reference signals to be measured based on downlink control information;
determining the maximum port number of non-zero-power channel state information reference signals to be measured based on the downlink control information; and
selecting or determining the port numbers of at least one group of non-zero-power channel state information reference signals to be measured based on the maximum port number.

5. The method according to claim 3, wherein:
channel state information reference signals with different port numbers are located in the same code division multiplexing group and/or the same resource pool; and/or
channel state information reference signals with different port numbers have the same or different non-zero power channel state information reference signal resource identifiers; and/or
channel state information reference signals with different port numbers have different non-zero power channel state information reference signal resource set identifiers.

6. The method according to claim 1, further comprising:
obtaining channel state information of an antenna port where the channel state information reference signal is located based on the measurement resource configuration information.

7. The method according to claim 6, wherein:
the downlink information is specific to each terminal device; and/or
the downlink information is downlink control information and/or radio resource control information; and/or
the channel state information reference signal is a non-zero-power channel state information reference signal and/or a zero-power channel state information reference signal; and/or
the channel state information is at least one of a channel quality indicator, a precoding matrix indicator, a channel state information reference signal resource indicator, a layer indicator, and a rank indicator; and/or
the measurement resource configuration information is configured to obtain the channel state information of the antenna port where the channel state information reference signal is located.

8. A processing method, comprising:
transmitting downlink information, enabling a terminal device to generate or determine measurement resource configuration information of at least one channel state information reference signal based on the downlink information.

9. The method according to claim 8, wherein:
the downlink information is specific to each terminal device; and/or
the downlink information is shared by the terminal devices in a preset group; and/or
the downlink information is shared by all terminal devices within a preset cell.

10. The method according to claim 9, wherein:
terminal devices belonging to the same preset group have the same quality of service requirements; and/or
reference signal received power of terminal devices belonging to the same preset group is greater than a first preset threshold and does not exceed a second preset threshold.

11. The method according to claim 8, wherein the transmitting the downlink information, enabling the terminal device to generate or determine the measurement resource configuration information of at least one channel state information reference signal based on the downlink information comprises at least one of the following:
transmitting the downlink information, enabling the terminal device to select or determine, based on the downlink information, the port numbers for a channel state information reference signal to be measured;
transmitting the downlink information, enabling the terminal device to select or determine, based on the downlink information, higher-layer parameters for at least one group of channel state information reference signals with a certain port numbers that meet a preset rule; and
transmitting the downlink information, enabling the terminal device to select or determine, based on the higher-layer parameters, a time domain resource location and/or a frequency domain resource location occupied by the channel state information reference signal in a slot.

12. The method according to claim 11, wherein the meeting the preset rule comprises at least one of the following:
at least one of a density, a code division multiplexing type, and a frequency domain range in the high-layer parameters of the channel state information reference signals with different port numbers is the same;
at least one of a first frequency domain resource allocation, a first symbol of a first time domain, and a first symbol of a second time domain in the higher-layer parameters of the channel state information reference signals with different port numbers is the same; and
the first frequency domain resource allocation in the higher-layer parameters of the channel state information reference signals with different port numbers is a subset of the first frequency domain resource allocation in the higher-layer parameters of the channel state information reference signal with the maximum port number in a resource pool where the port number resides.

13. The method according to claim 11, wherein the terminal device selecting or determining, based on the downlink information, the port numbers for the channel state information reference signal to be measured comprises at least one of the following:
the terminal device determining the port numbers of at least one group of non-zero-power channel state information reference signals to be measured based on downlink control information;
the terminal device determining the maximum port number of non-zero-power channel state information reference signals to be measured based on the downlink control information; and
the terminal device selecting or determining the port numbers of at least one group of non-zero-power channel state information reference signals to be measured based on the maximum port number.

14. The method according to claim 12, wherein:
the channel state information reference signals with different port numbers are located in the same code division multiplexing group and/or the same resource pool; and/or
the channel state information reference signals with different port numbers have the same or different non-zero power channel state information reference signal resource identifiers; and/or
the channel state information reference signals with different port numbers have different non-zero power channel state information reference signal resource set identifiers.

15. The method according to claim 8, further comprising:
configuring number of antenna ports required for physical downlink shared channel transmission based on channel state information.

16. The method according to claim 15, wherein:
the downlink information is downlink control information and/or radio resource control information; and/or
the channel state information reference signal is a non-zero-power channel state information reference signal and/or a zero-power channel state information reference signal; and/or
the channel state information is at least one of a channel quality indicator, a precoding matrix indicator, a channel state information reference signal resource indicator, a layer indicator, and a rank indicator; and/or
the measurement resource configuration information is configured to obtain the channel state information of the antenna port where the channel state information reference signal is located.

17. The method according to claim 16, further comprising:
configuring antenna port numbers required for physical downlink shared channel transmission based on the channel state information.

18. A communications device, comprising: a memory, a processor, and a processing program stored in the memory and executable on the processor, wherein the processing program, when executed by the processor, implements the processing method according to claim 1.

19. A communications device, comprising: a memory, a processor, and a processing program stored in the memory and executable on the processor, wherein the processing program, when executed by the processor, implements the processing method according to claim 8.

20. A non-transitory computer-readable storage medium, wherein the non-transitory computer-readable storage medium stores a computer program, and the computer program, when executed by a processor, implements the processing method according to claim 1.
